(19) United States
(12) Patent Application Publication
(10) Pub. No.: US 2017/0350555 A1
(43) Pub. Date: Dec. 7, 2017

(54) PORTABLE ELECTRONIC DEVICE HOLDERS WITH STAND SYSTEM AND METHODS TO MANUFACTURE PORTABLE ELECTRONIC DEVICE HOLDERS WITH STAND SYSTEM

(71) Applicant: Karsten Manufacturing Corporation, Phoenix, AZ (US)

(72) Inventors: Martin R. Jertson, Phoenix, AZ (US); Paul D. Wood, Phoenix, AZ (US); Erik M. Henrikson, Phoenix, AZ (US); Alex Hope, Phoenix, AZ (US); Calvin S. Wang, Chandler, AZ (US); Samuel J. Pendred, Denford (GB)

(21) Appl. No.: 15/686,696

(22) Filed: Aug. 25, 2017

Related U.S. Application Data
(63) Continuation-in-part of application No. 14/738,731, filed on Jun. 12, 2015.
Application No. 14/738,731 is a continuation-in-part of application No. 14/015,172, filed on Aug. 30, 2013, now Pat. No. 9,108,096.
(60) Provisional application No. 62/481,771, filed on Apr. 5, 2017.
(60) Provisional application No. 62/468,508, filed on Mar. 8, 2017.
(60) Provisional application No. 62/380,300, filed on Aug. 26, 2016.

(51) Int. Cl. F16M 13/02; A63B 69/36; F16M 11/24; A63B 60/00; F16M 11/04; F16B 2/22; F16B 2/12; F16M 11/14; F16M 11/16; G03B 17/56

(52) U.S. Cl. CPC F16M 13/022; F16M 11/14; A63B 69/36; F16M 11/242; F16M 11/16; A63B 60/00; F16M 11/041; F16B 2/22; F16B 2/12; F16M 2200/022; G03B 17/561

(57) ABSTRACT

Embodiments of portable electronic device holders and methods of manufacture of portable electronic device holders are generally described herein. Other embodiments may be described and claimed.

### CROSS-REFERENCE

This claims the benefit of U.S. Provisional Application No. 62/481,771, filed May 4, 2017, U.S. Provisional Application No. 62/468,508, filed Mar. 8, 2017, and U.S. Provisional Application No. 62/380,300, filed Aug. 26, 2016, and is also a continuation in part of U.S. patent application Ser. No. 14/738,731, filed Jun. 12, 2015, which is a continuation in part of U.S. patent application Ser. No. 14/015,172, filed Aug. 30, 2013, now U.S. Pat. No. 9,108,096, all the contents of which are incorporated herein by reference.

### FIELD OF THE INVENTION

The present disclosure relates generally to sport accessories, and more particularly, to portable electronic device holders and methods to manufacture portable electronic device holders.

### BACKGROUND OF THE INVENTION

In golf, some training devices may be an integral part of a golf club (i.e., built-in). That is, the golf club may not be readily used for play in a round of golf. Alternatively, other training devices may only function as a golf training device such that the training device may not be used for other purposes. Instead of the types of training devices for golf mentioned above, individuals may use already-owned and/or everyday-used portable electronic devices as a training device for golf.

### BRIEF DESCRIPTION OF THE DRAWINGS

FIG. 1 shows a perspective view of a portable electronic device holder according to one embodiment.

FIG. 2 shows a rear perspective view of the portable electronic device holder of FIG. 1.

FIG. 3 shows a rear perspective view of the portable electronic device holder of FIG. 1 shown attached to a golf club shaft.

FIG. 4 shows a top view of the portable electronic device holder of FIG. 1.

FIG. 5 shows a bottom view of the portable electronic device holder of FIG. 1.

FIG. 6 shows a side view of the portable electronic device holder of FIG. 1.

FIG. 7 shows another side view of the portable electronic device holder of FIG. 1 shown attached to a golf club shaft.

FIGS. 8 and 9 show side views of a section of the portable electronic device holder of FIG. 1.

FIG. 10 shows a front view of the portable electronic device holder of FIG. 1 with an exemplary portable electronic device mounted on the portable electronic device holder.

FIG. 11 shows a method of manufacturing a portable electronic device holder according to one embodiment.

FIG. 12 shows a perspective view of a portable electronic device holder according to another embodiment.

FIG. 13 shows a rear perspective view of the portable electronic device holder of FIG. 12.

FIG. 14 shows a bottom view of the portable electronic device holder of FIG. 12.

FIG. 15 shows a top view of the portable electronic device holder of FIG. 12.

FIG. 16 shows a side view of the portable electronic device holder of FIG. 12.

FIG. 17 shows another side view of the portable electronic device holder of FIG. 12 shown attached to a golf club shaft.

FIGS. 18 and 19 show side views of a section of the portable electronic device holder of FIG. 12.

FIG. 20 shows a front view of the portable electronic device holder of FIG. 12 with an exemplary portable electronic device mounted on the portable electronic device holder.

FIG. 21 shows a perspective view of a stand system for an exemplary portable electronic device holder.

FIG. 22 shows an enlarged perspective view of the stand system of FIG. 21.

FIG. 23 shows a perspective view of a coupling member of the stand system of FIG. 21.

FIG. 24 shows another perspective view of the coupling member of FIG. 23.

FIG. 25 shows a bottom view of the coupling member of FIG. 24.

FIG. 26 shows a front perspective view of a portable electronic device holder according to another embodiment.

FIG. 27 shows a rear perspective view of the portable electronic device holder of FIG. 26.

FIG. 28 shows a front perspective view of a portable electronic device holder according to another embodiment.

FIG. 29 shows a rear perspective view of the portable electronic device holder of FIG. 28.

FIG. 30 shows a front perspective view of a portable electronic device holder according to another embodiment.

FIG. 31 shows a rear perspective view of the portable electronic device holder of FIG. 30.

FIG. 32 shows a front perspective view of a portable electronic device holder according to another embodiment.

FIG. 33 shows a top view of the portable electronic device holder of FIG. 32.

FIG. 34 shows a rear view of the portable electronic device holder of FIG. 32.

FIG. 35 shows a side view of the portable electronic device holder of FIG. 32.

FIG. 36 shows another front perspective view of the portable electronic device holder of FIG. 32.

### DETAILED DESCRIPTION

In general, apparatus, methods, and articles of manufacture associated with a portable electronic device holder are described herein. The methods, apparatus, and articles of manufacture described herein are not limited in this regard.

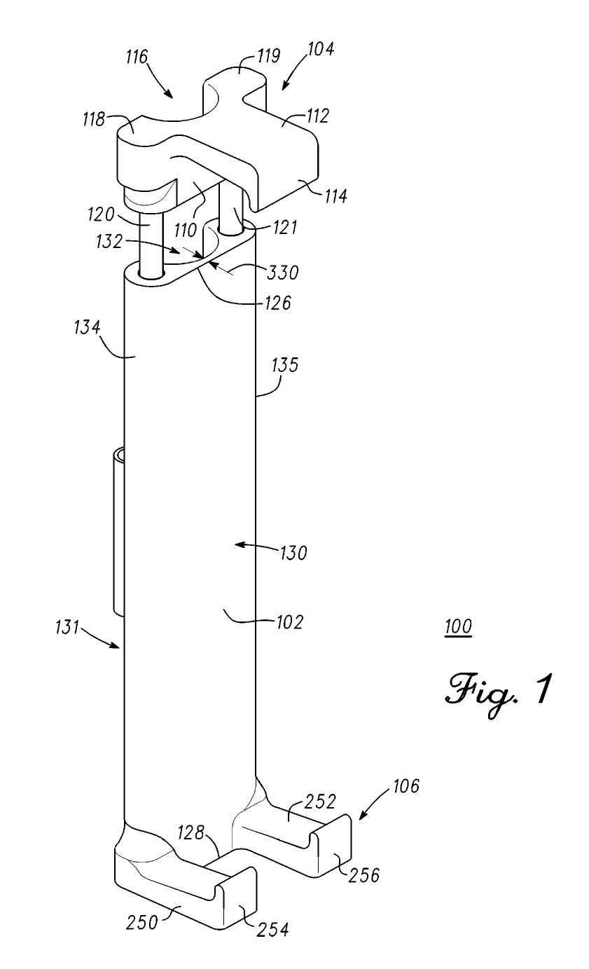

FIGS. 1-10 illustrate a portable electronic device holder 100 according to an embodiment of the present invention. The device holder 100 may include a body portion 102, a first clamp portion 104 and a second clamp portion 106. As described in detail below, the portable electronic device holder 100 may be configured to removably attach a portable electronic device 1000 (generally shown in FIGS. 7 and 10) such as a wireless communication device and/or a portable media player to a golf club shaft 800 (generally shown in FIGS. 3-5, 7 and 10) of a golf club (e.g., a putter-type golf club). For example, the portable electronic device 1000 may be a media player (e.g., an IPOD® mobile digital device from Apple Inc., Cupertino, Calif.), a wireless telephone (e.g., an IPHONE® mobile digital device from Apple Inc., Cupertino, Calif.), a handheld or tablet computer (e.g., an IPAD® from Apple Inc., Cupertino, Calif.), a global positioning system (GPS) device, a game console device, a digital camera, a video camera, and/or any other electronic device that may be include any type of sensor (e.g., accelerometer, gyroscope, microphone, CCD imaging sensor, CMOS imaging sensor, etc.) for sensing and collecting data and/or images. The portable electronic device 1000 may be configured to operate as a training device (e.g., the portable electronic device 1000 may include a processor to execute a software application), such as a golf training device. In addition or alternatively, the portable electronic device 1000 may be configured to operate as a telephone or a speaker broadcasting music. As shown by the example of FIGS. 7 and 10, a portable electronic device 1000 may include a bottom portion 1002, a top portion 1004, a first side portion 1006, a second side portion 1008 that is opposite to the first side portion 1006, a display portion 1010 and a back portion 1012 (shown in FIG. 7). However, a portable electronic device may be in any shape such as oval, circular, triangular, spherical or other geometric and non-geometric shapes. Accordingly, a first clamp portion 104 and a second clamp portion 106 may be configured to provide engagement with any portable electronic device. The apparatus and articles of manufacture described herein are not limited in this regard.

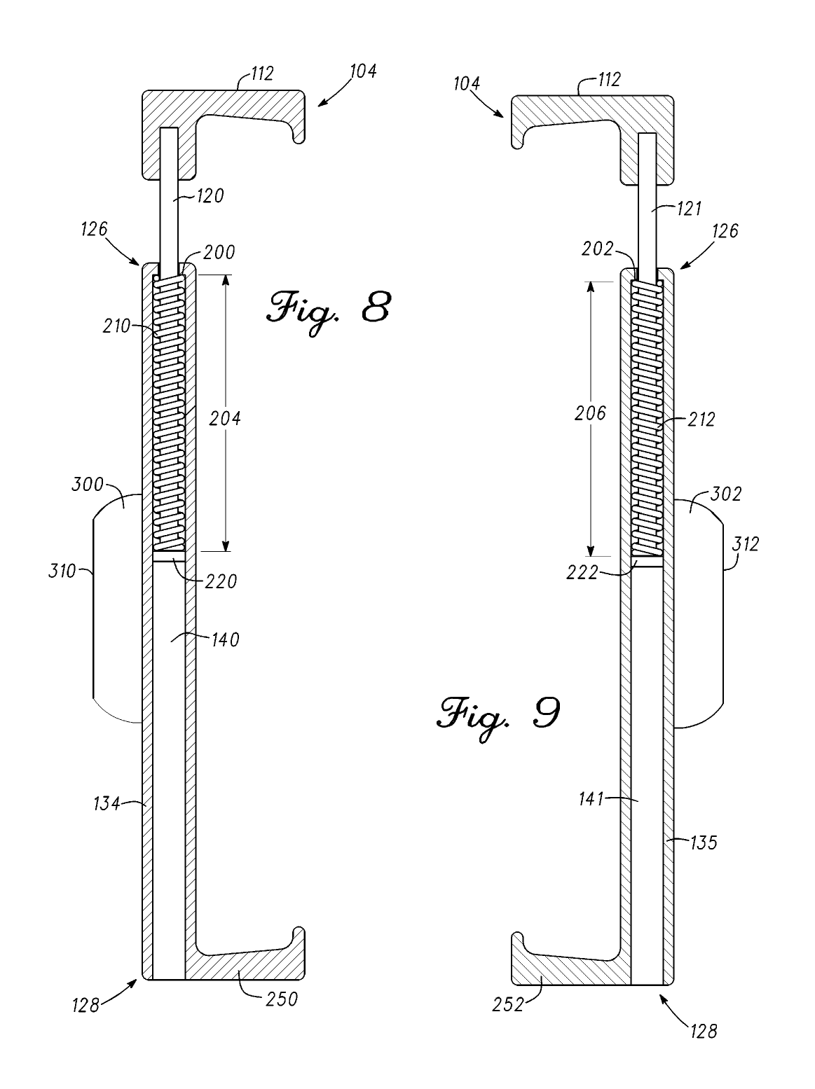

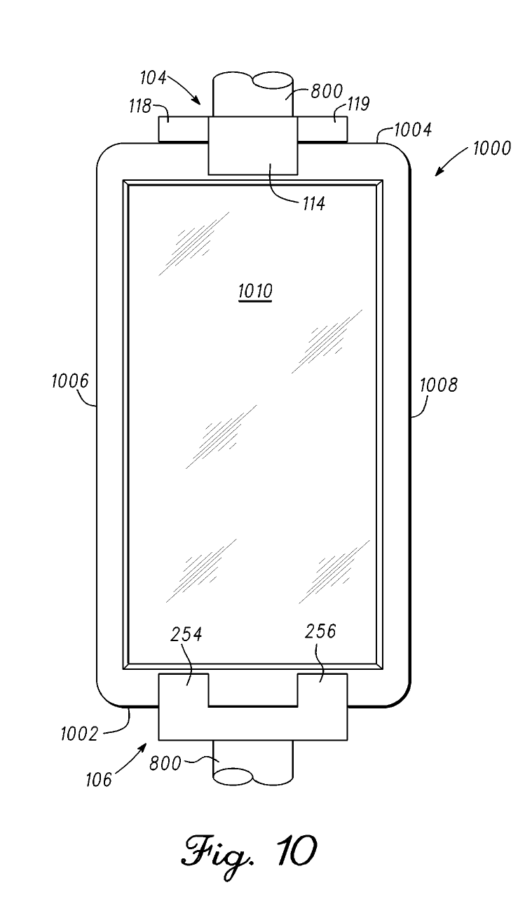

The first clamp portion 104 includes a first clamp body 110 and a first clamp arm 112 that is connected to the first clamp body 110 and extends transverse or generally perpendicular to the first clamp body 110. At the free end of the first clamp arm 112, the first clamp arm 112 includes a lip portion 114 extending generally transverse to the first clamp arm 112 and toward the second clamp portion 106. The first clamp body 110 includes a generally circular or curved channel 116 on a back side of the clamp body 110, which may be the side of the clamp body 110 that is opposite to the side of the first clamp body 110 to which the first clamp arm 112 is connected. The clamp body 110 includes a first rod attachment portion 118 and a second rod attachment portion 119, which may be located on opposite sides of the curved channel 116. A first rod 120 is attached to the first rod attachment portion 118 (shown in FIG. 8) and a second rod 121 is attached to the second rod attachment portion 119 (shown in FIG. 9). Accordingly, as shown in FIG. 1, two generally parallel and spaced apart rods 120 and 121 are attached to and extend from the first clamp body 110. The first rod 120 and the second rod 121 may be constructed with the clamp body 110 or constructed as separate pieces that are attached to the clamp body 110. For example, as shown in FIGS. 8 and 9, the first rod 120 and the second rod 121 may be separately constructed parts that are inserted into slots or bores of the first rod attachment portion 118 and the second rod attachment portion 119 and attached to the first rod attachment portion 118 and the second rod attachment portion 119, respectively. The first clamp portion 104 may include more than one clamp arm. For example the first clamp portion 104 may include a pair of spaced apart clamp arms (not shown). The methods, apparatus, and articles of manufacture described herein are not limited in this regard.

The body portion 102 includes a first end portion 126 and a second end portion 128. The first end portion 126 and the second end portion 128 may define a length of the body portion 102. The body portion 102 includes a front surface 130 that may extend from the first end portion 126 to the second end portion 128, and a generally curved channel 132 on a back portion 131, which is a portion of the body portion 102 that is behind the front surface 130. The body portion 102 further includes a first rod housing 134 and a second rod housing 135, which may be located on opposite sides of the curved channel 132 and extend along the length of the body portion 102. The first rod housing 134 includes a first rod passage 140 (shown in FIG. 8) that may be configured to accommodate a portion of the first rod 120 or the entire first rod 120. The second rod housing 135 includes a second rod passage 141 (shown in FIG. 9) that may be configured to accommodate a portion of second rod 121 or the entire second rod 121. Accordingly, the first clamp portion 104 may be movable from a position where the first clamp portion 104 abuts the body portion 102 and the first rod 120 and the second rod 121 are substantially inside the first rod passage 140 and the second rod passage 141, respectively, to a position where the first clamp portion 104 is spaced apart from the body portion 102 (shown for example in FIG. 1) and the first rod 120 and the second rod 121 are partially inside the first rod passage 140 and the second rod passage 141, respectively.

Referring to FIGS. 8 and 9, the first rod housing 134 includes a first aperture 200 at the first end portion 126. Portions of the first rod 120 may traverse in and out the first rod passage 140 through the first aperture 200. Similarly, the second rod housing 135 includes a second aperture 202 at the first end portion 126. Portions of the second rod 121 may traverse in and out of the second rod passage 141 through the second aperture 202. A diameter of each aperture 200 and 202 may be slightly greater than the outer diameter of the first rod 120 and the second rod 121, but is smaller than the inner diameter of the first rod passage 140 and the second rod passage 141, respectively. At a position along the first rod 120 or at the free end of the first rod 120, the first rod 120 includes a first stop 220, which may be cylindrical-shaped or disc-shaped. The stop 220 may have a diameter that is greater than the diameter of the first rod 120 and slightly smaller than the inner diameter of the first rod passage 140. Accordingly, a first annular passage 204 may be defined in the first rod passage 140 between the first stop 220 and the first aperture 200. Movement of the first rod 120 through the first rod passage 140 changes the length of the first annular passage 204. Similarly, at a position along the second rod 121 or at the free end of the second rod 121, the second rod 121 includes a second stop 222, which may be cylindrical-shaped or disc-shaped. The second stop 222 has a diameter that is greater than the diameter of the second rod 121 and slightly smaller than the inner diameter of the second rod passage 141. Accordingly, a second annular passage 206 may be defined in the second rod passage 141 between the second stop 222 and the second aperture 202. Movement of the second rod 121 through the second rod passage 141 changes the length of the second annular passage 206.

A first spring 210 is disposed in the first annular passage 204. The first spring 210 has a coil diameter that is smaller than the inner diameter of the first rod passage 140, greater than the diameter of the first aperture 200 and smaller than the diameter of the first stop 220. Accordingly, the first spring 210 is bound in the first annular passage 204. Similarly, a second spring 212 is disposed in the second annular passage 206. The second spring 212 has a coil diameter that is smaller than the inner diameter of the second passage 141, greater than the diameter of the second aperture 202 and smaller than the diameter of the second stop 222. Accordingly, the second spring 212 is bound inside the second annular passage 206.

Movement of the first rod 120 in the first rod passage 140 changes the length of the first annular passage 204. When the first rod 120 is moving in a direction out of the first rod passage 140, the first stop 220 compresses the first spring 210 against the first end portion 126 (i.e., around the first aperture 200) such that the first spring 210 exerts a force on the first stop 220 opposite to the movement of the first rod 120. When the first rod 120 is moving in a direction into the first rod passage 140, the first stop 220 allows the first spring 210 to decompress such that the force exerted by the spring on the first stop 220 is reduced.

Movement of the second rod 121 in the second rod passage 141 changes the length of the second annular passage 206. When the second rod 121 is moving in a direction out of the second rod passage 141, the second stop 222 compresses the second spring 212 against the first end portion 126 (i.e., around the second aperture 202) such that the second spring 212 exerts a force on the second stop 222 opposite to the movement of the second rod 121. When the second rod 121 is moving in a direction into the second rod passage 141, the second stop 222 allows the second spring 212 to decompress such that the force exerted by the spring on the second stop 222 is reduced.

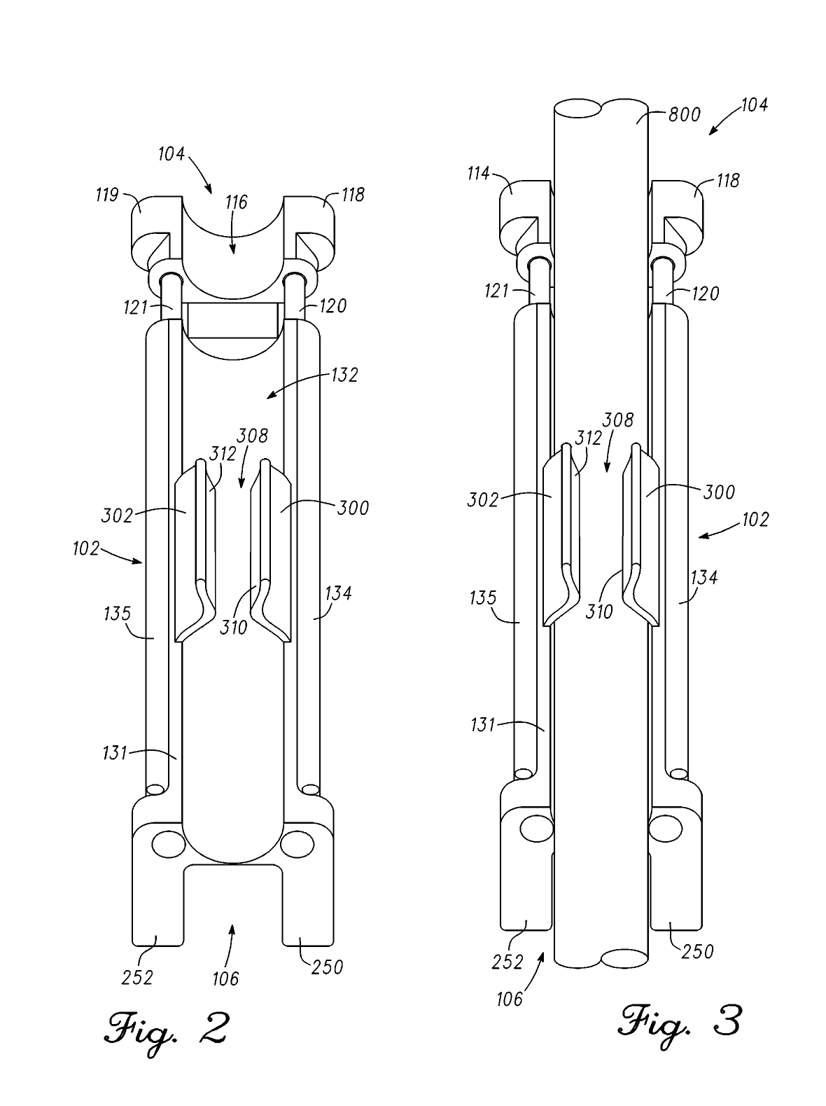

The second clamp portion 106 (shown for example in FIGS. 1 and 2) includes a second clamp arm 250 and a third clamp arm 252 that may be spaced apart to collectively provide a sufficiently wide support for a portable electronic device such as the portable electronic device 1000. Each of the second clamp arm 250 and the third clamp arm 252 extends transversely from the body portion 102. The second clamp arm 250 may include a second lip portion 254 and the third clamp arm 252 may include a third lip portion 256. Each of the second lip portion 254 and the third lip portion 256 may extend toward the first clamp portion 104. The second clamp portion 106 may include a single clamp arm similar to the first clamp portion 104 or more than two clamp arms. Each clamp arm 250 and 252 may be fixed to the body portion 102 or be movable relative to the body portion 102 similar to the first clamp arm 112 of the first clamp portion 104. The methods, apparatus, and articles of manufacture described herein are not limited in this regard.

When the first clamp portion 104 is abutting the body portion 102, the first spring 210 and the second spring 212 may be compressed. Accordingly, the first clamp portion 104 may be pressed and maintained against the body portion 102 by the forces of the first spring 210 and the second spring 212. When the first clamp portion 104 is moved or pulled away from the body portion 102, a portion of the first rod 120 and a portion of the second rod 121 are moved out of the first passage 140 and the second passage 141 to reduce the length of the first annular passage 204 and the second annular passage 206, respectively. Accordingly, the first spring 210 and the second spring 212 are further compressed in the first annular passage 204 and the second annular passage 206 to increase the forces in the first spring 210 and the second spring 212, respectively. The first clamp portion 104 may be further moved or pulled away from the body portion 102 until the first spring 210 and the second spring 212 are fully compressed, i.e., can no longer be compressed. Thus, the first clamp portion 104 may be moved to any position from an initial position where the first clamp portion 104 is pressed against the body portion 102 and the springs 210 and 212 are compressed to a final position where the first spring 210 and the second spring 212 are fully compressed. The forces of the first spring 210 and the second spring 212 return the first clamp portion 104 to the initial position from any position between the initial position and the final position. The initial position of the first clamp portion 104 may define the smallest distance between the first clamp arm 112 and the second and third clamp arms 250 and 252. The final position of the first clamp portion 104 may define the largest distance between the first clamp arm 112 and the second and third clamp arms 250 and 252.

According to another embodiment, when the first clamp portion 104 is abutting the body portion 102, i.e., the initial position, the first spring 210 and the second spring 212 may be expanded. The springs 210 and 212 may be positioned in the first rod passage 140 and the second rod passage 141 between the second end portion 106 and the stops 220 and 222, respectively (not shown). The springs 210 and 212 are further expanded when the first clamp portion 104 is moved to any position from the initial position to the final position. The final position of the first clamp portion 104 may correspond to a position where the stops 220 and 222 contact the first end portion 104 (not shown).

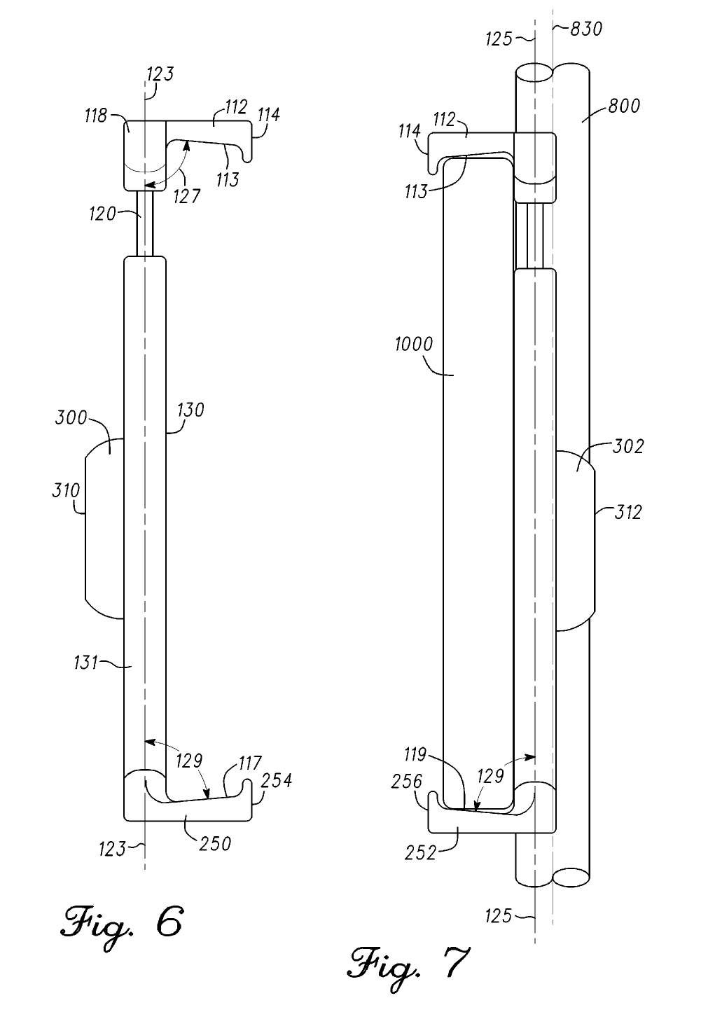

The portable electronic device holder 100 can hold a portable electronic device between the first clamp arm 112 and the second and third clamp arms 250 and 252 by the clamp arms 112, 250 and 252 pressing on opposing surfaces, portions or sides of the portable electronic device with the forces of the first spring 210 and the second spring 212. Referring to FIGS. 6 and 7, a first inner surface 113 of the first clamp arm 112 may define an acute angle 127 with the direction of the forces exerted on the first clamp portion 104 by the springs 210 and 212. In FIGS. 6 and 7, the forces exerted on the first clamp portion 104 by the springs are shown to be generally in the same direction as the longitudinal axis 123 of the first rod 120 and/or the longitudinal axis 125 of the second rod 121. In other words, the first inner surface 113 is downwardly inclined relative to the body portion 102. Similarly, the second inner surface 117 of the second clamp arm 250 and the third inner surface 119 of the third clamp arm 252 may define an acute angle 129 with the longitudinal axis 123 and/or the longitudinal axis 125. In other words, the second inner surface 117 and the third inner surface 119 are upwardly inclined relative to the body portion 102. When the portable electronic device 1000 is pressed by the first inner surface 113, the second inner surface 117 and the third inner surface 119, the acute angles 127 and 129 cause a component of force to be exerted on the portable electronic device 1000 in a direction toward the body portion 102. Thus, as the first clamp arm 112 and the second and third clamp arms 250 and 252 press on opposing surfaces, portions or sides of the portable electronic device 1000, the portable electronic device may be pushed and/or maintained against the front surface 130 of the body portion 102.

Portable electronic devices of varying sizes may be held by the portable electronic device holder 100 by moving the first clamp portion 104 between the initial position and the final position to increase or decrease the distance between the first clamp arm 112 and the second and third clamp arms 250 and 252. For example, referring to FIG. 10, a rectangular portable electronic device 1000 may be held by the first clamp arm 112 and the second and third clamp arms 250 and 252 pressing against two opposing sides 1002 and 1004 of the portable electronic device 1000. Alternatively, the portable electronic device 1000 may be held by the first clamp arm 112 and the second and third clamp arms 250 and 252 pressing against the two opposing sides 1006 and 1008 of the portable electronic device 1000 (not shown). In another example, a circular portable electronic device (not shown) may be held with the portable electronic device holder 100 by the first clamp arm 112 and the second and third clamp arms 250 and 252 engaging radially opposing perimeter edges, surfaces and/or portions of the circular electronic device. Accordingly, a portable electronic device having any shape may be held by the portable electronic device holder 100 as long as two opposing sides, surfaces and/or portions of the portable electronic device can be engaged and held by the first clamp arm 112 and the second and third clamp arms 250 and 252.

A portable electronic device 1000 may be mounted on to the portable electronic device holder 100 by pulling the first clamp portion 104 away from the body portion 102 until the distance between the first lip portion 114 and the second and third lip portions 254 and 256 is greater than a distance between two opposing edges, surfaces and/or portions of the portable electronic device. The portable electronic device 1000 may then be inserted into the portable electronic device holder 100 by the back portion 1012 being moved toward the front surface 130 until the back portion 1012 abuts the front surface 130 and the bottom portion 1002 rests on the second and third clamp arms 250 and 252. The first clamp arm 112 may then be released or moved toward the body portion 102 so that the first clamp arm 112 engages the second side 1004 of the portable electronic device. Alternatively, the first clamp portion 104 may be pulled away from the body portion 102 until the distance between the first clamp arm 112 and the second and third clamp arms 250 and 252 is greater than a distance between two opposing edges, surfaces and/or portions of the portable electronic device 1000. The portable electronic device 1000 may then be inserted into the portable electronic device holder 100 by being slipped in-between the first clamp arm 112 and the second and third clamp arms 250 and 252 (i.e., the back portion 1012 being moved generally parallel to the front surface 130) and the bottom portion 1002 being rested on the second and third clamp arms 250 and 252. The first clamp arm 112 may then be released or moved toward the body portion 102 so that the first clamp arm 112 engages the top portion 1004 of the portable electronic device.

The forces generated by the compression of the first spring 210 and the second spring 212 cause the first clamp arm 112 and the second and third clamp arms 252 and 254 to press against the portable electronic device 1000 and frictionally hold the portable electronic device 1000 in the portable electronic device holder 100. The first clamp arm 112 and/or the second and third clamp arms 250 and 252 may include a frictional material and/or surface texture that may enhance the frictional engagement between the clamp arms 112, 250 and 252 and the portable electronic device 1000. For example, each of the clamp arms 112, 250 and 252 may include a rubber or high density foam pad that engages the portable electronic device 1000. According to another example, the portion of each of the clamp arms 112, 250 and 252 that engages the portable electronic device 1000 may have a certain texture that enhances the frictional engagement with the portable electronic device 1000.

The first lip portion 114 and the second and third lip portions 254 and 256 may engage a front surface or the display portion 1010 of the portable electronic device 1000 to further assist in holding the portable electronic device 1000 in the portable electronic device holder 100. To remove the portable electronic device 1000 from the portable electronic device holder 100, the first clamp portion 104 may be moved or pulled away from the body portion 102 so that the first clamp arm 112 is sufficiently spaced from the first side 1002 of the portable electronic device 1000 to allow removal of the portable electronic device 1000 from the portable electronic device holder 100.

The portable electronic device holder 100 may be mounted on a shaft of sports equipment or any cylindrical object. Referring to FIGS. 2-5, 7 and 10, the portable electronic device holder 100 may be mounted on a golf club shaft 800. The portable electronic device holder 100 may engage the golf club shaft 800 at any location on the golf club shaft 800. The curved channel 132 of the body portion 102 is located opposite to the front surface 130. Additionally, the curved channel 116 of the first clamp portion 104 may be linearly aligned with the curved channel 132 of the body portion 102. The curved channels 132 and 116 collectively define an elongated substantially linear channel having a concave curvature relative to the front surface 130. Furthermore, the length of the channel defined by the curved channel 132 and the curved channel 116 can increase or decrease based on the position of the first clamp portion 104 relative to the body portion 102. The curved channels 132 and 116 can receive a longitudinal portion of a shaft such as a golf club shaft 800. The channels 132 and 116 may be tapered from the first clamp portion 104 to the second end portion 106 to generally correspond to a taper in the golf club shaft 800. For example, the diameter of the golf club shaft 800 may decrease from the grip portion (not shown) to the head portion (not shown). Accordingly, the diameter or width of the channels 132 and 116 may decrease from the first clamp portion 104 to the second end portion 106. The channels 132 and 116 may have any dimensional variation from the first clamp portion 104 to the second end portion 106 to correspond to a similar dimensional variation in the golf club shaft 800. Although the channels 132 and 116 are described and shown as curved channels, the channels 132 and 116 may have any shape that corresponds to the shape of a certain shaft. For example, the channels 132 and 116 may have an oval shape to receive a shaft having an oval cross section. In another example, the channels 132 and 116 may have a triangular shape to receive a shaft having a triangular shape. The methods, apparatus, and articles of manufacture described herein are not limited in this regard.

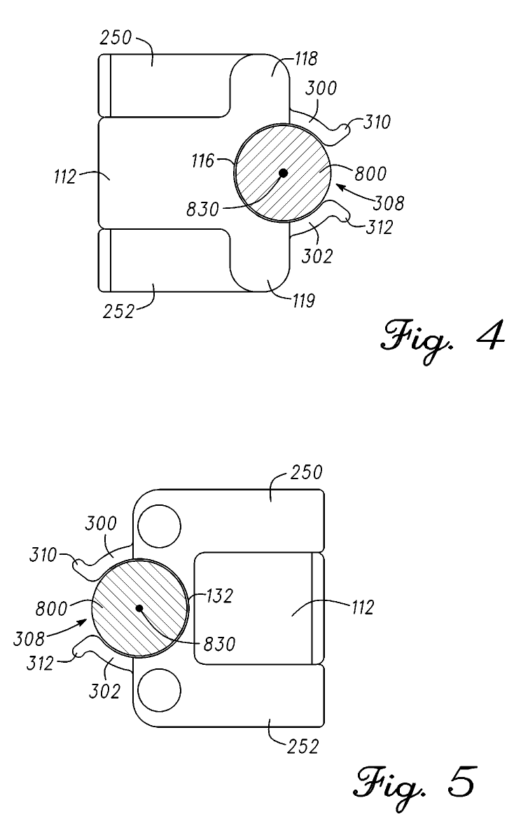

Referring to FIGS. 2-7, the portable electronic device holder 100 may further include at least a pair of arms 300 and 302 that are spaced apart and disposed on opposite sides of the channel 132. The arms 300 and 302 and the curved channel 132 may collectively define a generally cylindrical passage 306 for receiving a portion of the golf club shaft 800 through an opening 308 that is defined by the space between the arms 300 and 302. According to one example, the arms 300 and 302 may be shaped to substantially continue the curvature of the curved channel 132. For example, as shown in FIGS. 4 and 5, if the cross section of the channel 132 defines a radial portion of a circle, then the arms 300 and 302 may define other radial portions of the same circle. Movement of the arms 300 and 302 from a rest position to widen or narrow the opening 308 can elastically bend the body portion 102, e.g., widen or narrow the channel 132. Accordingly, the elastic bending of the body portion 102 provides a biasing force for returning the arms 300 and 302 to the rest position. Alternatively, the arms 300 and 302 may be elastically flexible and/or be flexibly attached to the body portion 102. Each arm 300 and 302 may also include an expansion tab 310 and 312 that may extend along at least a portion of the arm 300 and 302, respectively. Each expansion tab 310 and 312 extends outwardly from the corresponding arm 300 and 302 to effectively enlarge the opening 308.

The generally transverse orientation of each expansion tab 310 and 312 relative to a corresponding direction of the arm 300 and 302, respectively, provides for the elastic bending of the arms 300 and 302, the channel 132 and/or the body portion 102 when a golf club shaft 800 is pressed against the expansion tabs 310 and 312. Accordingly, when a golf club shaft 800 is pressed against the expansion tabs 310 and 312, the golf club shaft 800 presses the expansion tabs 310 and 312 outward to elastically enlarge the opening 308 so that the golf club shaft 800 may be received in the cylindrical passage 306. Upon the golf club shaft 800 being inserted in the cylindrical passage 306, the elastic restoring force of the arms 300 and 302, the channel 132 and/or the body portion 102 move or snap the arms 300 and 302 back toward the pre-expanded position to frictionally engage the golf club shaft 800 in cooperation with the curved channel 132. The curved channel 132 and or the arms 300 and 302 may collectively define a partial oval cross-sectional shape, circular cross-sectional shape, rectangular cross-sectional shape, or any other shape that may be similar to correspondingly shaped shaft. The methods, apparatus, and articles of manufacture described herein are not limited in this regard.

A portable electronic device may be mounted on the golf club shaft 800 with the portable electronic device holder 100 to capture still and/or video images of an area around the portable electronic device; measure and/or determine relative and/or absolute linear motion, velocity and/or acceleration of the portable electronic device; measure and/or determine relative and/or absolute angular motion, velocity and/or acceleration of the portable electronic device; and/or measure and/or determine relative and/or absolute position of the portable electronic device. Referring to FIGS. 4, 5 and 7, the curved channel 132 and the curved channel 116 allow the axis 830 of the golf club shaft 800 to be located close to the front surface 130 of the portable electronic device holder 100, hence close to the portable electronic device 1000 when the portable electronic device 1000 is attached to the golf club shaft 800 with the portable electronic device holder 100. Accordingly, any of the above-described motion, velocity, acceleration and/or position measurements and/or determinations associated with the portable electronic device 1000 may be interpreted as motion, velocity, acceleration and/or position measurements and/or determinations associated with the golf club shaft 800. The distance 330 (shown in FIG. 1) between the bottom of the curved channel 132 and the front surface 130 (i.e., the smallest thickness of the material between the front surface 130 and the lowest point on the curved channel 132) may be optimally minimized based on the materials and/or methods of construction of the portable electronic device holder 100. For example, for a device holder constructed from a highly rigid material such as titanium, the distance may be smaller than a device holder constructed from a less rigid material such as plastic. Thus, the size and curvature of the curved channel 132 and the distance 330 may be optimally determined to place the axis 830 of the golf club shaft 800 as close as possible to the portable electronic device 1000.

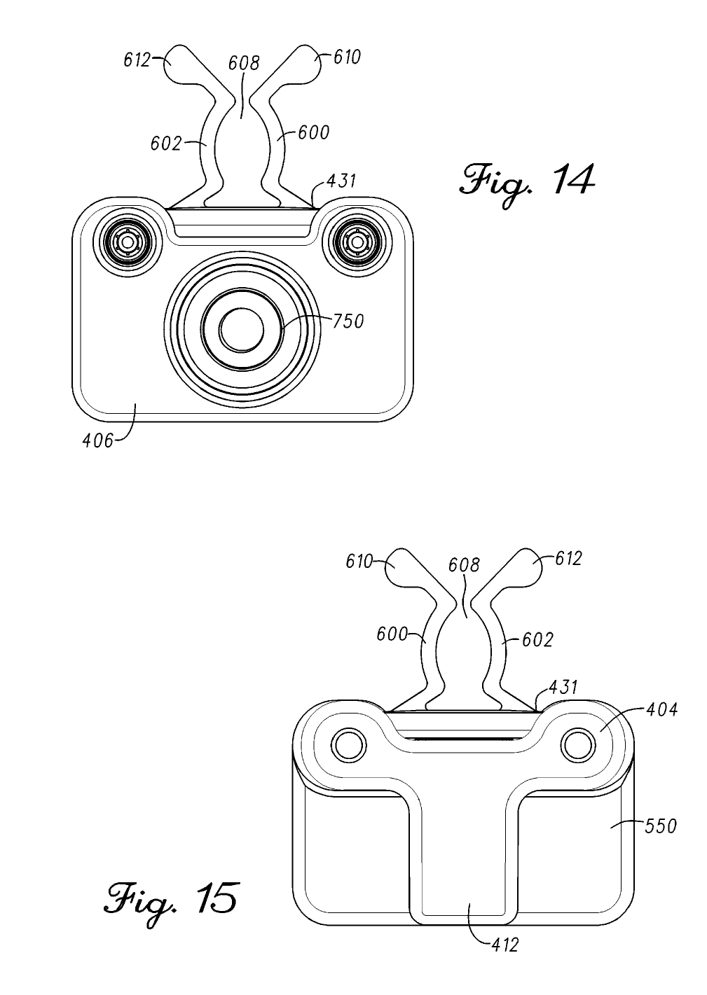

FIGS. 12-20 illustrate another exemplary embodiment of the portable electronic device holder 400. Portable electronic device holder 400 may be similar to portable electronic device holder 100, with like numbers referencing similar components. The portable electronic device holder 400 may include a body portion 402, a first clamp portion 404 and a second clamp portion 406. The portable electronic device holder 400 may be configured to removably attach a portable electronic device 1000 such as a wireless communication device and/or a portable media player to a golf club shaft 800 (generally shown in FIGS. 17 and 18) of a golf club (e.g., a putter-type golf club), similar to the portable electronic device holder 100. Accordingly, first clamp portion 404 and a second clamp portion 406 may be configured to provide engagement with any portable electronic device. The apparatus and articles of manufacture described herein are not limited in this regard.

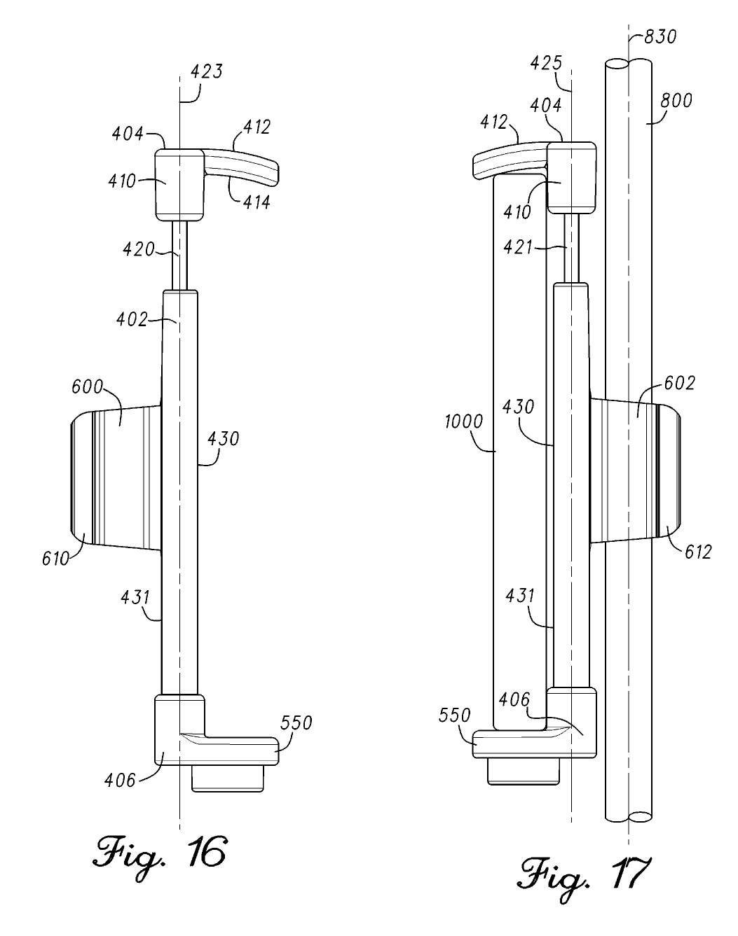

The first clamp portion 404 includes a first clamp body 410 and a first clamp arm 412 that is connected to the first clamp body 410 and extends substantially transverse to the first clamp body 410. The first clamp arm 412 has an arcuate shape defining a curved surface 414 (see FIG. 16). The curved surface 414 allows the free end of the first clamp arm 412 to extend toward the second clamp portion 406 such that the free end of the first clamp arm 412 is closer to the second clamp portion 406 than the attached end of the first clamp arm 412.

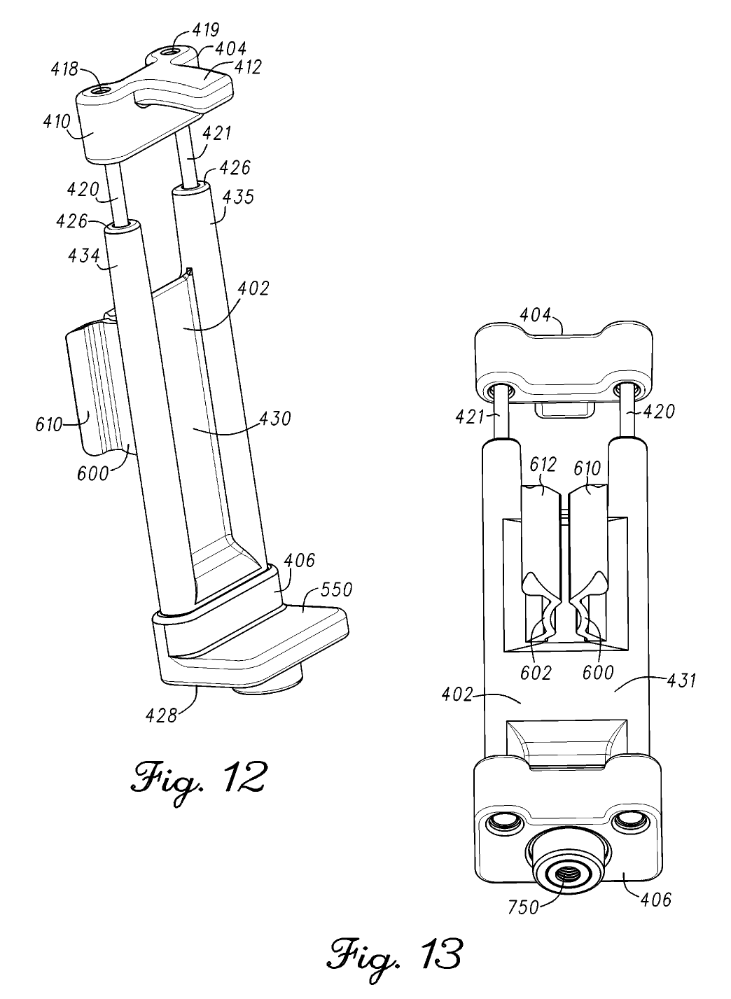

The clamp body 410 includes a first rod attachment portion 418 and a second rod attachment portion 419. A first rod 420 is attached to the first rod attachment portion 418 and a second rod 421 is attached to the second rod attachment portion 419 (shown in FIG. 12). Accordingly, as shown in FIG. 12, two generally parallel and spaced apart rods 420 and 421 are attached to and extend from the first clamp body 410. The first rod 420 and the second rod 421 may be constructed with the clamp body 410 or constructed as separate pieces that are attached to the clamp body 410. For example, as shown in FIGS. 12 and 13, the first rod 420 and the second rod 421 may be separately constructed parts that are inserted into slots or bores of the first rod attachment portion 418 and the second rod attachment portion 419 and attached to the first rod attachment portion 418 and the second rod attachment portion 419, respectively. In the illustrated embodiment, the first clamp portion 404 includes the first clamp arm 412. In other embodiments, the first clamp portion 404 may include more than one clamp arm. For example, the first clamp portion 404 may include a pair of spaced apart clamp arms (not shown). The methods, apparatus, and articles of manufacture described herein are not limited in this regard.

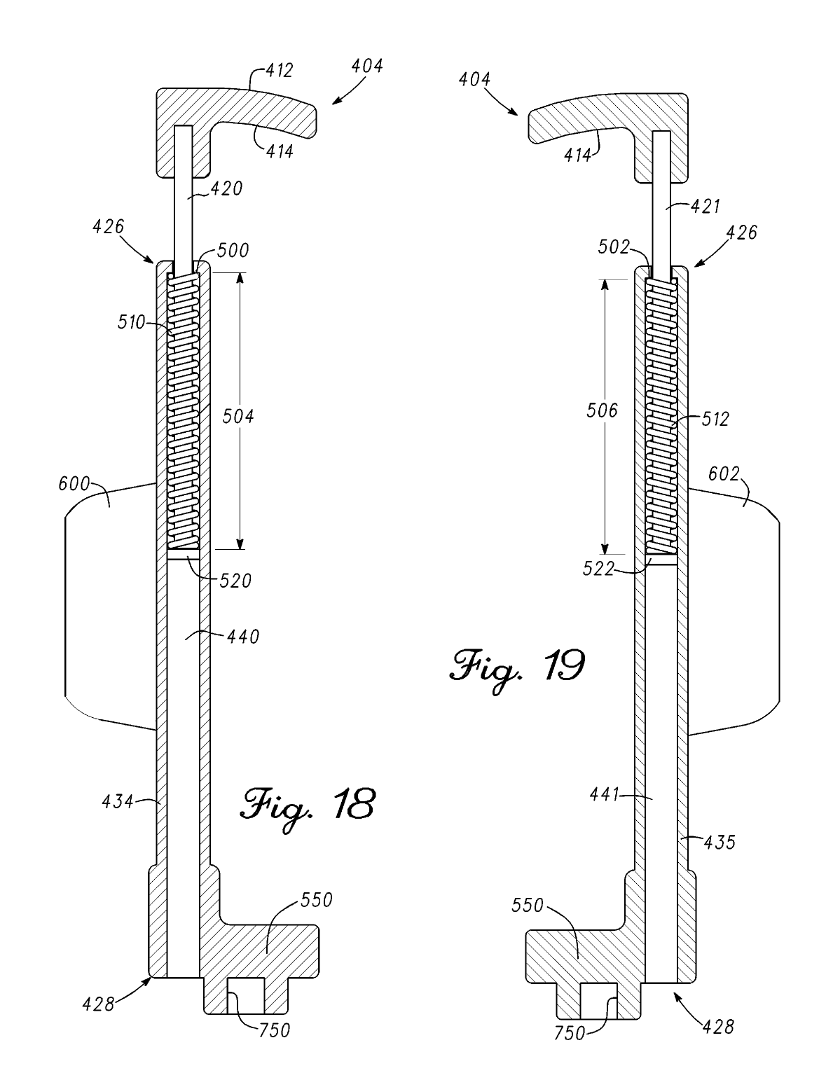

The body portion 402 includes a first end portion 426 and a second end portion 428. The first end portion 426 and the second end portion 428 may define a length of the body portion 402. The body portion 402 includes a front surface 430 and a back surface 431 that may extend from the first end portion 426 to the second end portion 428. The body portion 402 further includes a first rod housing 434 and a second rod housing 435, which may extend along the length of the body portion 402. The first rod housing 434 includes a first rod passage 440 (FIG. 18) that is configured to accommodate a portion of the first rod 420 or the entire first rod 420. The second rod housing 435 includes a second rod passage 441 (FIG. 19) that is configured to accommodate a portion of second rod 421 or the entire second rod 421. Accordingly, the first clamp portion 404 may be movable from a position where the first clamp portion 404 abuts the body portion 402 and the first rod 420 and the second rod 421 are substantially inside the first rod passage 440 and the second rod passage 441, respectively, to a position where the first clamp portion 404 is spaced apart from the body portion 402 (shown for example in FIG. 12). The first rod 420 and the second rod 421 are partially inside the first rod passage 440 and the second rod passage 441, respectively.

Referring to FIGS. 18 and 19, the first rod housing 434 includes a first aperture 500 at the first end portion 426. Portions of the first rod 420 may traverse in and out the first rod passage 440 through the first aperture 500. Similarly, the second rod housing 435 includes a second aperture 502 at the first end portion 426. Portions of the second rod 421 may traverse in and out of the second rod passage 441 through the second aperture 502. A diameter of each aperture 500, 502 may be slightly greater than the outer diameter of the first rod 420 and the second rod 421, but smaller than the inner diameter of the first rod passage 440 and the second rod passage 441, respectively. At a position along the first rod 420 or at the free end of the first rod 420, the first rod 420 includes a first stop 520 which may be cylindrical-shaped or disc-shaped. The first stop 520 may have a diameter that is greater than the diameter of the first rod 420 and slightly smaller than the inner diameter of the first rod passage 440. Accordingly, a first annular passage 504 may be defined in the first rod passage 440 between the first stop 520 and the first aperture 500. Movement of the first rod 420 through the first rod passage 440 changes the length of the first annular passage 504. Similarly, at a position along the second rod 421 or at the free end of the second rod 421, the second rod 421 includes a second stop 522 which may be cylindrical-shaped or disc-shaped. The second stop 522 has a diameter that is greater than the diameter of the second rod 421 and slightly smaller than the inner diameter of the second rod passage 441. Accordingly, a second annular passage 506 may be defined in the second rod passage 441 between the second stop 522 and the second aperture 502. Movement of the second rod 421 through the second rod passage 441 changes the length of the second annular passage 506.

A first spring 510 is disposed in the first annular passage 504. The first spring 510 has a coil diameter that is smaller than the inner diameter of the first rod passage 440, greater than the diameter of the first aperture 500 and smaller than the diameter of the first stop 520. Accordingly, the first spring 510 is bound in the first annular passage 504. Similarly, a second spring 512 is disposed in the second annular passage 506. The second spring 512 has a coil diameter that is smaller than the inner diameter of the second rod passage 441, greater than the diameter of the second aperture 502 and smaller than the diameter of the second stop 522. Accordingly, the second spring 512 is bound inside the second annular passage 506.

Movement of the first rod 420 in the first rod passage 440 changes the length of the first annular passage 504. When the first rod 420 is moving in a direction out of the first rod passage 504, the first stop 520 compresses the first spring 510 against the first end portion 426 (i.e., around the first aperture) such that the first spring 510 exerts a force on the first stop 520 opposite to the movement of the first rod 420. When the first rod 420 is moving in a direction into the first rod passage 440, the first stop 520 allows the first spring 510 to decompress such that the force exerted by the first spring 510 on the first stop 520 is reduced.

Movement of the second rod 421 in the second rod passage 441 changes the length of the second annular passage 506. When the second rod 421 is moving in a direction out of the second rod passage 441, the second stop 522 compresses the second spring 512 against the first end portion 426 (i.e., around the second aperture) such that the second spring 512 exerts a force on the second stop 522 opposite to the movement of the second rod 421. When the second rod 421 is moving in a direction into the second rod passage 441, the second stop 522 allows the second spring 512 to decompress such that the force exerted by the second spring 512 on the second stop 522 is reduced.

Referring to FIG. 12, the second clamp portion 406 includes a second clamp arm 550 that extends transversely from the body portion 402. In other embodiments, the second clamp portion 406 may include more than one clamp arm. For example, the second clamp portion 406 may include a pair of spaced apart clamp arms (not shown). Further, in the illustrated embodiment, the second clamp arm 406 is substantially perpendicular to the body portion 402, thereby allowing the portable electronic device holder 400 to receive a portable electronic device of any width and thickness. The methods, apparatus, and articles of manufacture described herein are not limited in this regard.

When the first clamp portion 404 is abutting the body portion 402, the first spring 510 and the second spring 512 may be compressed. Accordingly, the first clamp portion 404 may be pressed and maintained against the body portion 402 by the forces of the first spring 510 and the second spring 512. When the first clamp portion 404 is moved or pulled away from the body portion 402, a portion of the first rod 420 and a portion of the second rod 421 are moved out of the first rod passage 440 and the second rod passage 441 to reduce the length of the first annular passage 504 and the second annular passage 506, respectively. Accordingly, the first spring 510 and the second spring 512 are further compressed in the first annular passage 504 and the second annular passage 506 to increase the forces in the first spring 510 and the second spring 512, respectively. The first clamp portion 404 may be further moved or pulled away from the body portion 402 until the first spring 510 and the second spring 512 are fully compressed, i.e., can no longer be compressed. Thus, the first clamp portion 404 may be moved to any position from an initial position where the first clamp portion 404 is pressed against the body portion 402 and the springs 510, 512 are compressed to a final position where the first spring 510 and the second spring 512 are fully compressed. The forces of the first spring 510 and the second spring 512 return the first clamp portion 404 to the initial position from any position between the initial position and the final position. The initial position of the first clamp portion 404 may define the smallest distance between the first clamp arm 412 and the second clamp arm 550. The final position of the first clamp portion 404 may define the largest distance between the first clamp arm 412 and the second clamp arm 550.

According to another embodiment, when the first clamp portion 404 is abutting the body portion 402, i.e., the initial position, the first spring 510 and the second spring 512 may be expanded. The springs 510, 512 may be positioned in the first rod passage 440 and the second rod passage 441 between the second end portion 406 and the first and second stops, 520, 522, respectively (not shown). The springs 510, 512 are further expanded when the first clamp portion 404 is moved to any position from the initial position to the final position. The final position of the first clamp portion 404 may correspond to a position where the stops 520, 522 contact the first end portion 404 (not shown).

The portable electronic device holder 400 can hold a portable electronic device 1000 between the first clamp arm 412 and the second clamp arm 550 by the clamp arms 412 and 550 pressing on opposing surfaces, portions or sides of the portable electronic device 1000 with the forces of the first spring 510 and the second spring 512. The forces exerted on the first clamp portion 404 by the first and the second spring 510, 512 are generally in the same direction as a longitudinal axis 423 (FIG. 16) of the first rod 420 and/or a longitudinal axis 425 (FIG. 17) of the second rod 421. The longitudinal forces exerted on the first clamp portion 404 by the springs 510, 512 aid in securing the portable electronic device 1000 within the portable electronic device holder 400 by preventing the portable electronic device 1000 from moving relative to the portable electronic device holder 400 in the direction of the longitudinal forces, due to the springs 510, 512. Thus, as the first clamp arm 412 and the second clamp arm 550 press on opposing surfaces, portions or sides of the portable electronic device 1000, the portable electronic device 1000 may be pushed, maintained, and/or secured between the first clamp portion 404 and the second clamp portion 406. Further, the curved surface 414 exerts a force generally perpendicular to the longitudinal axis 423 (FIG. 16) of the first rod 420 and/or the longitudinal axis 425 (FIG. 17) of the second rod 421, thereby further securing the portable electronic device 1000 in the portable electronic device holder 400 by preventing the portable electronic device 1000 from moving relative to the portable electronic device holder 400 in a direction of the perpendicular force, due to the downward inclination of the curved surface 414 relative to the body portion 402. When the portable electronic device 1000 is pressed by the first clamp arm 412 and the second clamp arm 550, the curved surface 414 exert a component of force on the portable electronic device 1000 in a direction toward the body portion 402. Therefore, the curved surface 414 of the portable electronic device holder 400 provides the same function as the first lip portion 114, the second lip portion 254, and the third lip portion 256 of the portable electronic device holder 100. In other words, the curved surface 414 and the first, the second and the third lip portions 114, 254, 256 all secure the portable electronic device 1000 within the portable electronic device holder by preventing movement of the portable electronic device 1000 relative to the portable electronic device holder in a direction generally perpendicular to the longitudinal axes 123, 423, 125, 425 and/or the front surface 430 of the body portion 402.

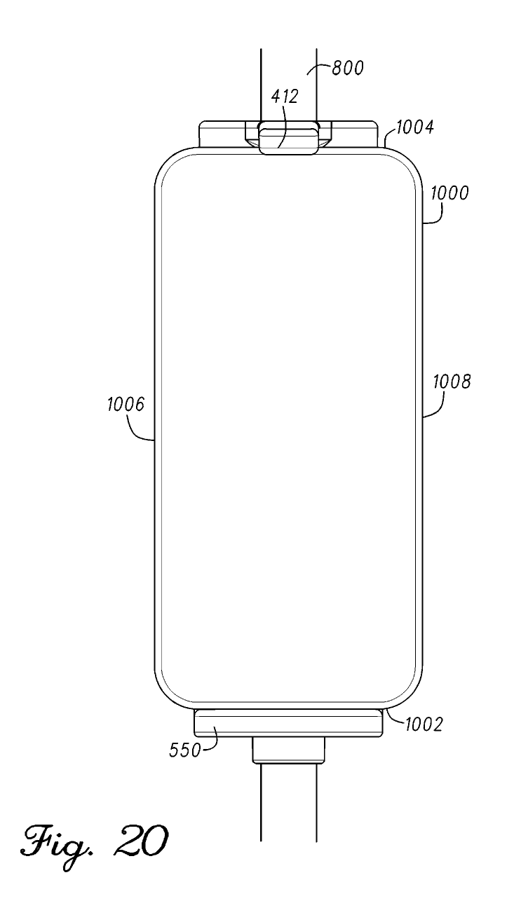

Portable electronic devices of varying sizes may be held by the portable electronic device holder 400 by moving the first clamp portion 404 between the initial position and the final position to increase or decrease the distance between the first clamp arm 412 and the second clamp arm 550. For example, referring to FIG. 20, a rectangular portable electronic device 1000 may be held by the first clamp arm 412 and the second clamp arm 550 pressing against two opposing sides 1002 and 1004 of the portable electronic device 1000. Alternatively, the portable electronic device 1000 may be held by the first clamp arm 412 and the second clamp arm 550 pressing against the two opposing sides 1006 and 1008 of the portable electronic device 1000 (not shown). In another example, a circular portable electronic device (not shown) may be held with the portable electronic device holder 100 by the first clamp arm 412 and the second clamp arm 550 engaging radially opposing perimeter edges, surfaces and/or portions of the circular electronic device. Accordingly, a portable electronic device having any shape may be held by the portable electronic device holder 400 as long as two opposing sides, surfaces and/or portions of the portable electronic device can be engaged and held by the first clamp arm 412 and the second clamp arm 550.

A portable electronic device 1000 may be mounted on to the portable electronic device holder 100 by pulling the first clamp portion 404 away from the body portion 402 until the distance between the first clamp arm 412 and the second clamp arm 550 is greater than a distance between two opposing edges, surfaces and/or portions of the portable electronic device. The portable electronic device 1000 may then be inserted into the portable electronic device holder 400 by the back portion (not shown) being moved toward the front surface 430 until the bottom portion 1002 rests on the second clamp arm 550. The first clamp arm 412 may then be released or moved toward the body portion 402 so that the first clamp arm 412 engages the second side 1004 of the portable electronic device. Alternatively, the first clamp portion 404 may be pulled away from the body portion 402 until the distance between the first clamp arm 412 and the second clamp arm 550 is greater than a distance between two opposing edges, surfaces and/or portions of the portable electronic device 1000. The portable electronic device 1000 may then be inserted into the portable electronic device holder 400 by being slipped in-between the first clamp arm 412 and the second clamp arm 550 (i.e., the back portion being moved generally parallel to the front surface 430) and the bottom portion 1002 being rested on the second clamp arm 550. The first clamp arm 412 may then be released or moved toward the body portion 402 so that the first clamp arm 412 engages the top portion 1004 of the portable electronic device.

The forces generated by the compression of the first spring 510 and the second spring 512 cause the first clamp arm 412 and the second clamp arm 550 to press against the portable electronic device 1000 and frictionally hold the portable electronic device 1000 in the portable electronic device holder 400. The longitudinal forces exerted on the first clamp portion 404 by the springs 510, 512 aid in securing the portable electronic device 1000 within the portable electronic device holder 400 by preventing the portable electronic device 1000 from moving relative to the portable electronic device holder 400 in the direction of the longitudinal forces, due to the springs 510, 512. Further, the curved surface 414 exerts a force generally perpendicular to the longitudinal axis 423 (FIG. 16) of the first rod 420 and/or the longitudinal axis 425 (FIG. 17) of the second rod 421, thereby further securing the portable electronic device 1000 in the portable electronic device holder 400 by preventing the portable electronic device 1000 from moving relative to the portable electronic device holder 400 in a direction of the perpendicular force, due to the downward inclination of the curved surface 414 relative to the body portion 402. The first clamp arm 412 and/or the second clamp arm 550 may include a frictional material and/or surface texture that may enhance the frictional engagement between the clamp arms 412, 550 and the portable electronic device 1000 and/or provide vibration damping and sound reduction during use. For example, each of the clamp arms 412, 550 may include a rubber or high density foam pad that engages the portable electronic device 1000. According to another example, the portion of each of the clamp arms 412, 550 that engages the portable electronic device 1000 may have a certain texture that enhances the frictional engagement with the portable electronic device 1000.

To remove the portable electronic device 1000 from the portable electronic device holder 400, the first clamp portion 404 may be moved or pulled away from the body portion 402 so that the first clamp arm 412 is sufficiently spaced from the first side 1002 of the portable electronic device 1000 to allow removal of the portable electronic device 1000 from the portable electronic device holder 400.

Referring to FIGS. 13-15, the portable electronic device holder 400 may further include at least a pair of arms including a first arm 600 and a second arm 602 that are spaced apart and positioned on the back surface 431 of the body portion 402. The arms 600 and 602 may be fixedly attached to the back surface 431 of the body portion 402. The arms 600 and 602 define an opening 608 capable of expanding to receive a portion of the golf club shaft 800. The arms 600 and 602 may be elastically flexible and/or be flexibly attached to the body portion 402. Each arm 600 and 602 may also include an expansion tab 610 and 612 that may extend along at least a portion of the arm 600 and 602, respectively. Each expansion tab 610 and 612 extends outwardly from the corresponding arm 600 and 602 to effectively enlarge the opening 608.

The generally transverse orientation of each expansion tab 610 and 612 relative to a corresponding direction of the arm 600 and 602, respectively, provides for the elastic bending of the arms 600 and 602 when a golf club shaft 800 is pressed against the expansion tabs 610 and 612. Accordingly, when a golf club shaft 800 is pressed against the expansion tabs 610 and 612, the golf club shaft 800 presses the expansion tabs 610 and 612 outward to elastically enlarge the opening 608 so that the golf club shaft 800 may be received in the opening 608. Upon the golf club shaft 800 being inserted in the opening 608, the elastic restoring force of the arms 600 and 602 move or snap the arms 600 and 602 back toward the pre-expanded position to frictionally engage the golf club shaft 800 in the opening 608. The arms 600 and 602 may collectively define a partial oval cross-sectional shape, circular cross-sectional shape, rectangular cross-sectional shape, or any other shape that may be similar to correspondingly shaped shaft. The methods, apparatus, and articles of manufacture described herein are not limited in this regard.

The portable electronic device holder 400 may be mounted on a shaft of sports equipment or any cylindrical object. The portable electronic device holder 400 may be mounted on the golf club shaft 800. The portable electronic device holder 400 may engage the golf club shaft 800 at any location on the golf club shaft 800. A portable electronic device may be mounted on the golf club shaft 800 with the portable electronic device holder 400 to capture still and/or video images of an area around the portable electronic device; measure and/or determine relative and/or absolute linear motion, velocity and/or acceleration of the portable electronic device; measure and/or determine relative and/or absolute angular motion, velocity and/or acceleration of the portable electronic device; and/or measure and/or determine relative and/or absolute position of the portable electronic device. Any of the above-described motion, velocity, acceleration and/or position measurements and/or determinations associated with the portable electronic device 1000 may be interpreted as motion, velocity, acceleration and/or position measurements and/or determinations associated with the golf club shaft 800.

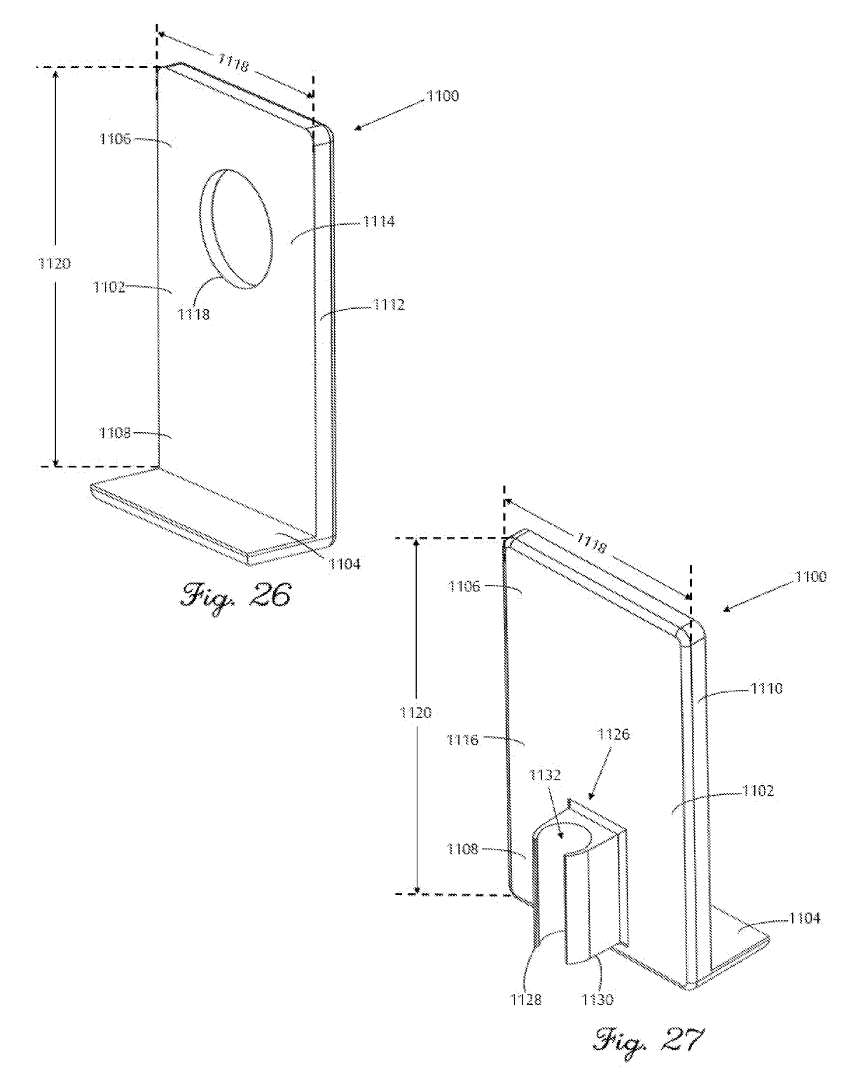

FIGS. 26-31 illustrate further embodiments of a portable electronic device holder 1100, 1200, and 1300. The portable device holder 1100, 1200, 1300 comprises a body portion 1102, 1202, 1302 and a base 1104, 1204, 1304. The portable electronic device holder 1100, 1200, 1300 may be configured to removably attach a portable electronic device 1000 such as a wireless communication device and/or portable media player to a golf club shaft 800 of a golf club (e.g., a putter-type golf club), similar to the portable electronic device holders 100 and 400.

The body portion 1102, 1202, 1302 comprises a first end portion 1106, 1206, 1306, a second end portion 1108, 1208, 1308, a first side 1110, 1210, 1310 and a second side 1112, 1212, 1312. A distance between the first end portion 1106, 1206, 1306 and the second end portion 1108, 1208, 1308 defines a length 1120, 1220, 1320 of the body portion 1102, 1202, 1302. A distance between the first side 1110, 1210, 1310 and the second side 1112, 1212, 1312 defines a width 1122, 1222, 1322 of the body portion 1102, 1202, 1302.

The body portion 1102, 1202, 1302 further comprises a front surface 1114, 1214, 1314 and a back surface 1116, 1216, 1316 that may extend from the first end portion 1106, 1206, 1306 to the second end portion 1108, 1208, 1308.

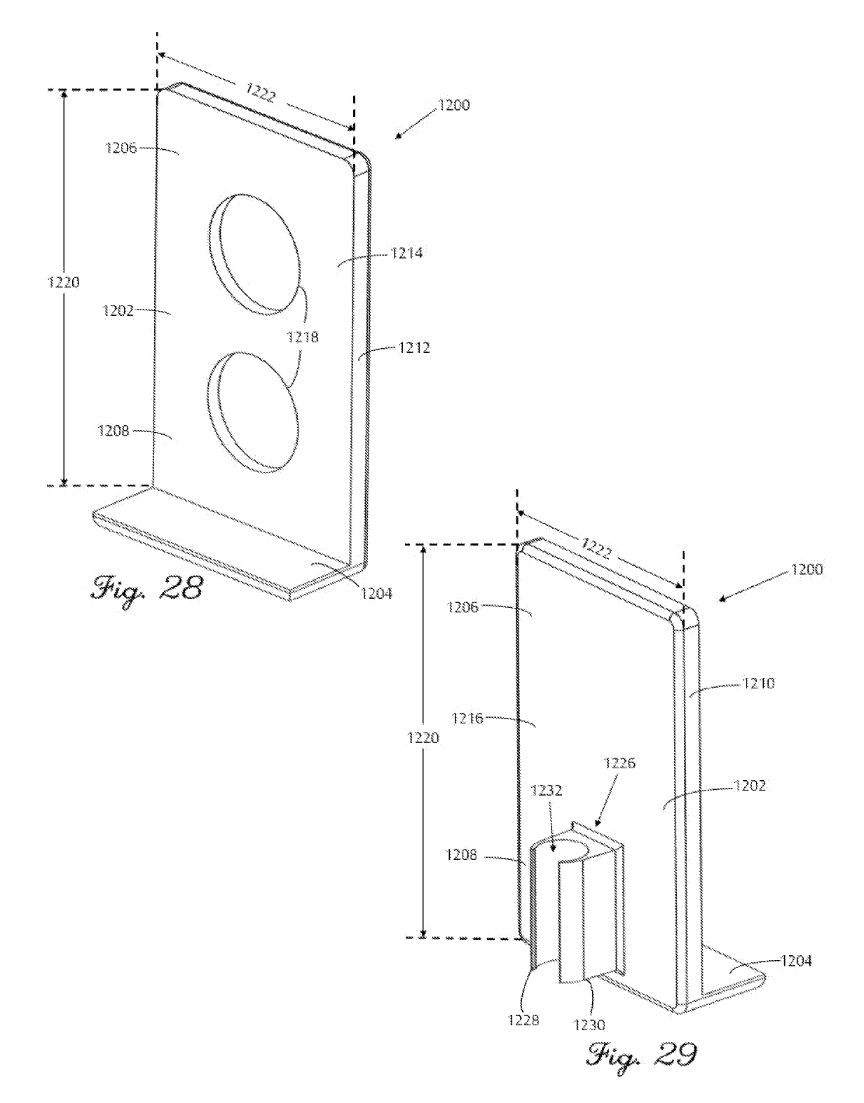

The body portion 1102, 1202, 1302 may further comprise a clamp (e.g., snap clamp, wherein applying a pressure on the clamp against a shaft will couple the clamp and shaft, producing a “snap” sound) 1126, 1226, 1326 positioned on the back surface 1116, 1216, 1316. In the embodiments illustrated, the clamp 1126, 1226, 1326 is centered along the width 1122, 1222, 1322 of the body portion 1102, 1202, 1302, and can be positioned anywhere along the length 1120, 1220, 1320 of the body portion 1102, 1202, 1302. For example, the clamp 1126, 1226, 1326 may be positioned on the back surface 1116, 1216, 1316 near the first end portion 1106, 1206, 1306, or be positioned on the back surface 1116, 1216, 1316 near the second end portion 1108, 1208, 1308 as illustrated in FIGS. 27, 29 and 31. Further, the clamp 1126, 1226, 1326 may have different orientations on the back surface 1116, 1216, 1316 (e.g., parallel to the first side 1110, 1210, 1310, perpendicular to the first side 1110, 1210, 1310, or different angles relative to the first side.)

The clamp 1126, 1226, 1326 comprises a first arm 1128, 1228, 1328 and a second arm 1130, 1230, 1330 wherein an opening 1132, 1232, 1332 defines a space between the first arm 1128, 1228, 1328 and the second arm 1130, 1230, 1330. The first arm 1128, 1228, 1328 and the second arm 1130, 1230, 1330 collectively define a generally cylindrical shape for receiving a portion of the golf club shaft 800, or any cylindrical object through the opening 1132, 1232, 1332. Once the clamp 1126, 1226, 1326 is snapped onto the golf club shaft 800, a friction generated between the golf club shaft 800 and the first arm 1128, 1228, 1328 and the second arm 1130, 1230, 1330 of the clamp 1126, 1226, 1326 prevent the portable electronic device holder 1100, 1200, 1300 from rotating and sliding on the golf club shaft 800. The general cylindrical shape created by the first arm 1128, 1228, 1328 and the second arm 1130, 1230, 1330 comprise a radius, wherein the radius can vary to accommodate different sized golf club shafts and cylindrical objects.

The base 1104, 1204, 1304 is integrally formed with the body portion 1102, 1202, 1302 and extends from the second end portion 1108, 1208, 1308 of the front surface 1114, 1214, 1314. The base extends the entire width 1122, 1222, 1322 of the body portion 1102, 1202, 1302. Furthermore, the base 1104, 1204, 1304 is perpendicular relative to the body portion 1102, 1202, 1302. The base 1104, 1204, 1304 prevents the portable electronic device 1000 from rotation when mounted to the body portion 1102, 1202, 1302.

The body portion 1102, 1202, 1302 further comprises at least one recess 1118, 1218, 1318 (e.g., 1 recess, 2 recesses, 3 recesses, 4 recesses, 5 recesses, or 6 recesses), wherein the at least one recess 1118, 1218, 1318 is located on the front surface 1114, 1214, 1314. The at least one recess 1118, 1218, 1318 can be positioned on any portion of the front surface 1114, 1214, 1314, such as: centered along the width 1122, 1222, 1322 of the body portion 1102, 1202, 1302, centered along the length 1120, 1220, 1320 of the body portion 1102, 1202, 1302, closer to the first side 1110, 1210, 1310, closer to the second side 1112, 1212, 1312, closer to the first end portion, closer to the second end portion 1108, 1208, 1308, in an alignment parallel to the first side 1110, 1210, 1310, in an alignment perpendicular to the first side 1110, 1210, 1310, aligned in a diagonal orientation, positioned at different corners of the body portion 1102, 1202, 1302, in a shape orientation (e.g., square, diamond, triangle, pentagon, etc.), or any combination thereof. For example, the body portion can comprise three recesses 1118, 1218, 1318, centered along the width 1122, 1222, 1322 of the body portion 1102, 1202, 1302, and aligned parallel to the first side 1110, 1210, 1310. Further the at least one recess 1118, 1218, 1318 can be any cross-sectional shape (e.g., circle, triangle, square, rectangle, etc.). The at least one recess 1118, 1218, 1318 described herein is a circular cross-sectional shape.

The at least one recess 1118, 1218, 1318 of the portable electronic device holder 1100, 1200, 1300 can further house at least one magnet 1124, 1224, 1324, wherein the at least one magnet 1124, 1224, 1324 comprises a cross-sectional shape that is complementary to the cross-sectional shape of the at least one recess 1118, 1218, 1318. In other embodiments, the at least one recess 1118, 1218, 1318 of the portable electronic device holder 1100, 1200, 1300 can comprise a polymagnet (programmable magnet). In other embodiments still, the portable electronic device holder 1100, 1200, 1300 can comprise a polymagnet. The at least one magnet 1124, 1224, 1324 may be positioned in the at least one recess 1118, 1218, 1318 by an adhesive (e.g., epoxy), press fit, molding a plastic of the portable electronic device holder 1100, 1200, 1300 around the at least one magnet 1124, 1224, 1324, 3-D printing the at least one magnet 1124, 1224, 1324 into the at least one recess 1118, 1218, 1318, or providing a portable electronic device holder 1100, 1200, 1300 comprising a ferrous material (i.e. any material that is magnetic).

In some embodiments, the portable electronic device holder 1100, 1200, 1300 can be made of polymagnets that may vary at different strengths of attraction. Further, the polymagnet can be programmable to be at different strengths of attraction. The polymagnets of the portable electronic device holder 1100, 1200, 1300 can comprise ferrous materials. Further, the polymagnets of the portable electronic device holder 1100, 1200, 1300 do not affect any surrounding magnetic fields (i.e., magnetic field of a gyroscope or any magnetic field within an electronic device).

When the at least one magnet 1124, 1224, 1324 is positioned in the at least one recess 1118, 1218, 1318, an exposed surface 1125, 1225, 1325 of the at least one magnet 1124, 1224, 1324 is flush with the front surface 1114, 1214, 1314. The exposed surface 1125, 1225, 1325 of the at least one magnet 1124, 1224, 1324 further comprises a polarity with respect to a magnetic field. The at least one magnet 1124, 1224, 1324, can be made of neodymium iron boron, samarium cobalt, alnico, ceramic, or any combination of ferromagnetic metals.

In other embodiments, the at least one magnet can be a polymagnet. The polymagnet can vary at different strengths of attraction to metals, polymagnets, ferrous materials or other materials. Further, the polymagnet can be programmable to be at different strengths of attraction. The polymagnet will not affect other surrounding magnetic fields (i.e., magnetic field of a gyroscope, or any magnetic field within an electronic device). In some embodiments, the polymagnet can comprise ferrous materials.

In one embodiment, as illustrated in FIGS. 26 and 27, the body portion 1102 comprises one recess 1118. The recess 1118 is centered along the width 1122 of the body portion 1102, and positioned near the first end portion 1106 of the body portion 1102. In other examples, the recess 1118 can be positioned anywhere along the entire length 1120 of the body portion 1102. For example, the recess 1118 can be positioned on the front surface 1114 near the first end portion 1106, near the second end portion 1108, or in the center of the length 1120 of the body portion 1102.

In another embodiment, as illustrated in FIGS. 28 and 29, the body portion 1202 comprises two recesses 1218. The two recesses 1218 are aligned parallel to the first side 1210 and are centered between the first side 1210 and the second side 1212 with one recess 1218 closer to the first end portion 1206, and the second recess 1218 closer to the second end portion 1208. In other examples, the two recesses 1218 can be aligned parallel to the first side 1210, and positioned closer to the first side 1210, or closer to the second side 1212. In other examples, the two recesses can be aligned parallel to the base 1204, and be positioned closer to the first end portion 1206, closer to the second end portion 1210, or in the center of the length 1220 of the body portion 1202. In other examples, the two recesses 1218 can be aligned in a diagonal orientation, from the first side 1210 near the first end portion 1206 towards the second side 1212 near the second end portion 1208, or from the first side 1210 near the second end portion 1208 towards the second side 1212 near the first end portion 1206. In further examples, the two recesses 1218 can be unaligned and be positioned on any portion of the front surface 1214.

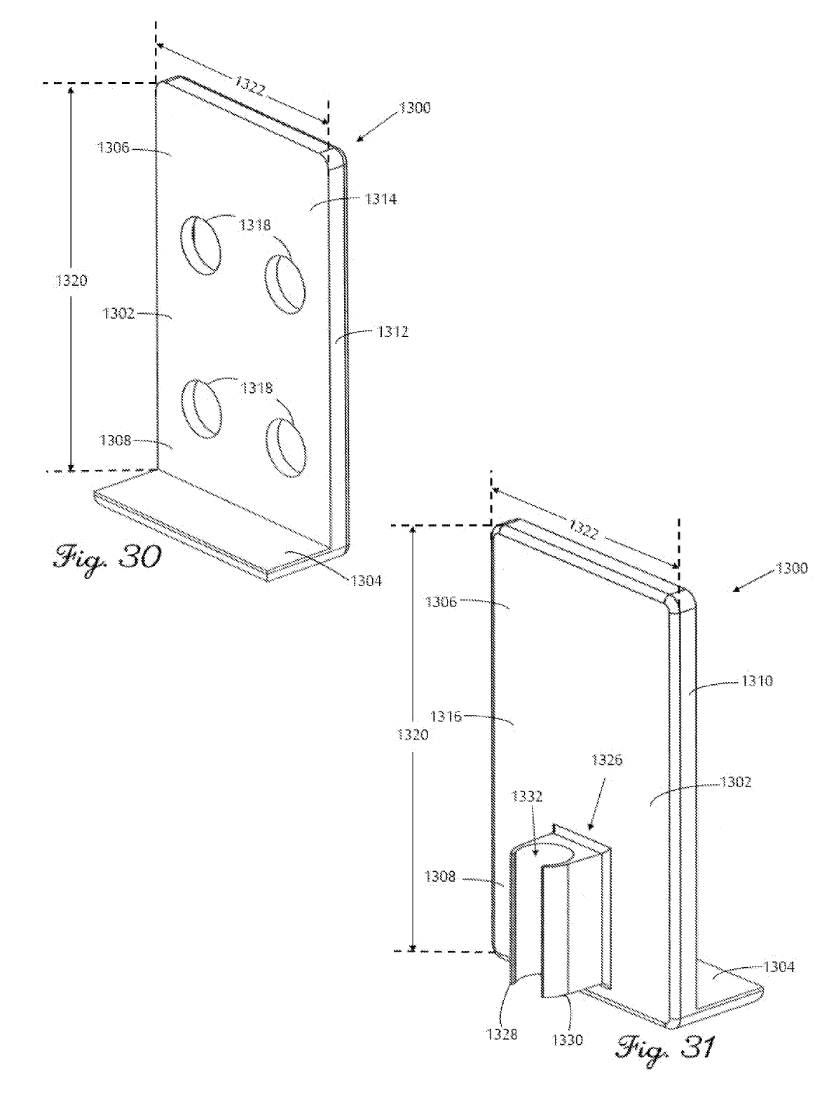

In another embodiment, as illustrated in FIGS. 30 and 31, the body portion 1302 comprises four recesses 1318. The four recesses 1318 are positioned on the front surface 1314 in a square orientation parallel to the first side 1310. In another example, the square orientation of the four recesses 1318 can be in a square orientation perpendicular to the first side 1310. In another example, each recess 1318 can be positioned at each corner of the body portion 1302. In another example, the four recesses 1318 can be aligned in a straight line parallel to the first side 1310 near the first side 1310, near the second side 1312, or centered along the width 1322 of the body portion 1302. In other examples, the four recesses 1318 can be aligned in a in a straight line diagonal orientation, from the first side 1310 closer to the first end portion 1306 towards the second side 1312 closer to the second end portion 1308, or from the first side 1310 closer to the second end portion 1308 towards the second side 1312 closer to the first end portion 1306. In further examples, the four recesses 1318 can be unaligned and be positioned on any portion of the front surface 1314.

When the at least one magnet 1124, 1224, 1324 is placed near a ferrous material (e.g., alloy steel, carbon steel, stainless steel, cast iron, etc.), or, the magnetic field of the at least one magnet 1124, 1224, 1324 causes the ferrous material to polarize. A force of attraction due to the polarity of the ferrous material and the polarity of the at least one magnet 1124, 1224, 1324, couples the ferrous material to the at least one magnet 1124, 1224, 1324.

There are several different approaches to incorporate a ferrous material to the portable electronic device 1000 so the portable electronic device 1000 may mount the portable electronic device holder 1100, 1200, 1300. In one approach, the portable electronic device 1000 may have a portable electronic device case made of the ferrous material. In another approach, the portable electronic device 1000 may have a portable electronic device case with a metal sheet made of the ferrous material positioned in between the portable electronic device 1000 and the portable electronic device case. The metal sheet comprises an adhesive surface wherein the adhesive surface can directly attach to the portable electronic device 1000 or to the portable electronic device case. The metal sheet can further comprise a design or logo on the surface opposite the adhesive surface. The force of attraction between the at least one magnet 1124, 1224, 1324 and the metal sheet, or the portable electronic device case made of the ferrous material, will keep the portable electronic device 1000 coupled to the portable electronic device holder 1100, 1200, 1300 until removal by a user. Further, the magnetic field of the at least one magnet 1124, 1224, 1324 will not harm the portable electronic device 1000 when mounted onto the portable electronic device holder 1100, 1200, 1300.

To remove the portable electronic device 1000 from the portable electronic device holder 1100, 1200, 1300, the portable electronic device 1000 and the electronic device case may be pulled away from the body portion 1102, 1202, 1302 so that the magnetic fields of the at least one magnet 1124, 1224, 1324 and the metal sheet, or the portable electronic device case made of the ferrous material do not create a force of attraction to one another.

The portable electronic device holder 1100, 1200, 1300 may be mounted on a shaft of sports equipment or any cylindrical object. The portable electronic device holder 1100, 1200, 1300 may be mounted on the golf club shaft 800. The portable electronic device holder 1100, 1200, 1300 may engage the golf club shaft 800 at any location on the golf club shaft 800. A portable electronic device may be mounted on the golf club shaft 800 with the portable electronic device holder 1100, 1200, 1300 to capture still and/or video images of an area around the portable electronic device; measure and/or determine relative and/or absolute linear motion, velocity and/or acceleration of the portable electronic device; measure and/or determine relative and/or absolute angular motion, velocity and/or acceleration of the portable electronic device; and/or measure and/or determine relative and/or absolute position of the portable electronic device. Any of the above-described motion, velocity, acceleration and/or position measurements and/or determinations associated with the portable electronic device 1000 may be interpreted as motion, velocity, acceleration and/or position measurements and/or determinations associated with the golf club shaft 800.

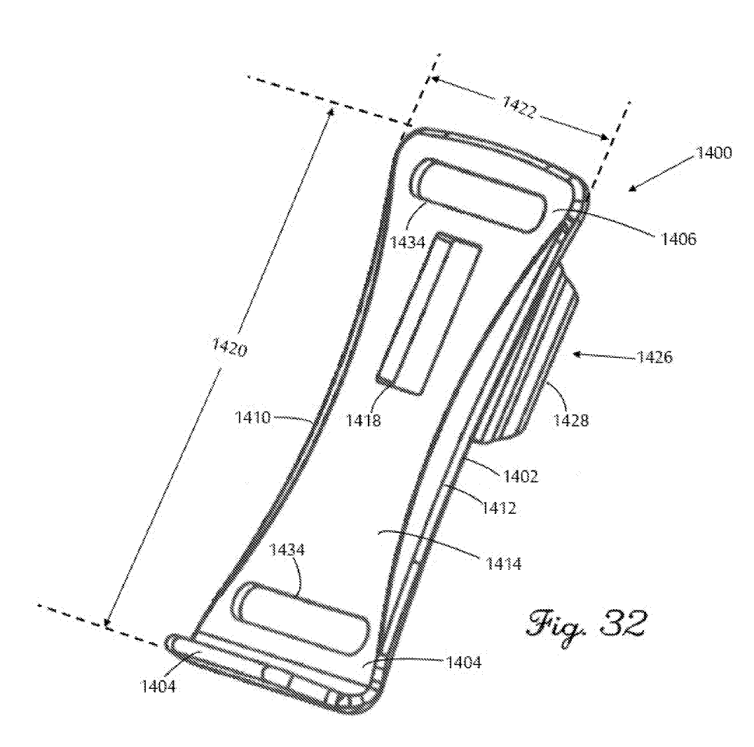

FIGS. 32-37 illustrate another embodiment of the portable electronic device holder 1400. The portable electronic device holder 1400 comprises a body portion 1402, and a base 1404. The portable electronic device holder 1400 may be configured to removable attach a portable electronic device 1000 such as a wireless communication device and/or portable media player to a golf club shaft 800 of a golf club (e.g., a putter-type golf club head), similar to the portable electronic device holders 100, 400, 1100, 1200, and 1300.

The body portion 1402 comprises a first end portion 1406, a second end portion 1408, a first side 1410 and a second side 1412. A distance between the first end portion 1406 and the second end portion 1408 defines a length 1420 of the body portion 1402. A distance between the first side 1410 and the second side 1412 defines a width 1422 of the body portion 1402. The first side 1410 of the body portion curves toward the second end 1412 of the body portion 1402, and the second side 1412 curves toward the first end 1410, wherein the width 1422 of the body portion 1402 is the greatest near the first and second end portion 1406, 1408. As illustrated in FIG. 32, due to the curve of the first and second sides 1410 and 1412, the portable electronic device holder 1400 can have a general hourglass shape. The body portion 1402 further comprises a front surface 1414 and a back surface 1416 that may extend from the first end portion 1406 to the second end portion 1408.

The body portion 1402 may further comprise a clamp (e.g., snap clamp, wherein applying a pressure on the clamp against a shaft will couple the clamp and shaft, producing a “snap” sound) 1426 positioned on the back surface 1416. In the embodiments illustrated, the clamp 1426 is centered along the width 1422 of the body portion 1402, and can be positioned anywhere along the length 1420 of the body portion 1402. For example as illustrated in FIG. 32, the clamp 1426 may be positioned centered along the width 1422 on the back surface 1416, near the first end portion 1406. Further, the clamp 1426 of the body portion 1402 may have different orientations on the back surface 1416 (e.g., perpendicular to the base 1404, or different angles relative to the base 1404.)

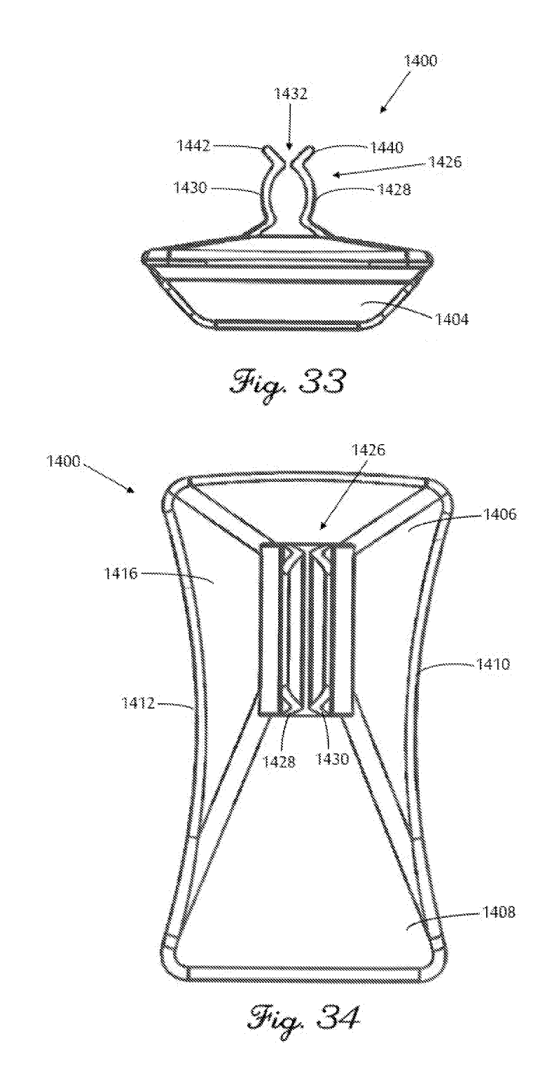

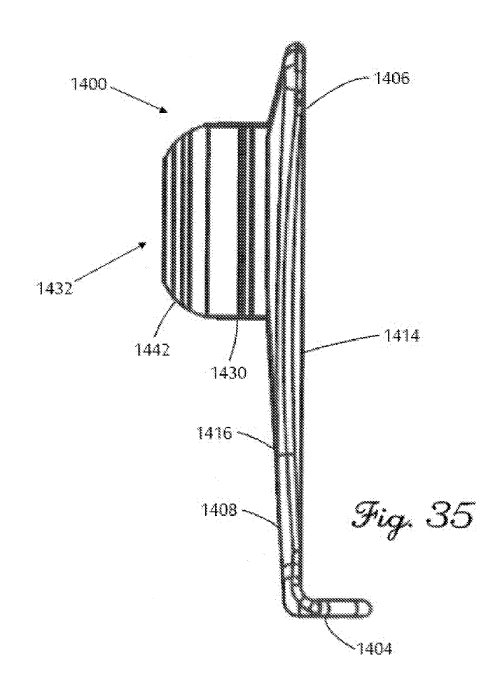

As illustrated in FIGS. 33 and 34, the clamp 1426 comprises a first arm 1428 and a second arm 1430 wherein an opening 1432 defines a space between the first arm 1428 and the second arm 1430. The first arm 1428 and the second arm 1430 collectively define a generally cylindrical shape for receiving a portion of the golf club shaft 800, or any cylindrical object through the opening 1432. Once the clamp 1426 is snapped onto the golf club shaft 800, a friction generated between the golf club shaft 800 and the first arm 1428 and the second arm 1430 of the clamp 1426 prevent the portable electronic device holder 1400 from rotating and sliding on the golf club shaft 800. The general cylindrical shape created by the first arm 1428 and the second arm 1430 comprise a radius, wherein the radius can vary to accommodate different sized golf club shafts and cylindrical objects.

The first and second arms 1428 and 1430 of the clamp 1426 may also include an expansion tab 1440 and 1442 that may extend along at least a portion of the first and second arms 1428 and 1430, respectively. Each expansion tab 1440 and 1442 extends outwardly from the corresponding arm 1428 and 1430 to effectively enlarge the opening 1432. The generally transverse orientation of each expansion tab 1440 and 1444 relative to a corresponding direction of the arm 1428 and 1430, respectively, provides for the elastic bending of the first and second arms 1428 and 1430 when a golf club shaft 800 is pressed against the expansion tabs 1440 and 1442. Accordingly, when a golf club shaft 800 is pressed against the expansion tabs 1440 and 1442, the golf club shaft 800 presses the expansion tabs 1440 and 1442 outward to elastically enlarge the opening 1432 so that the golf club shaft 800 may be received in the opening 1432.

In some embodiments, the back surface 1416 of the body portion 1402 can comprise a level surface. In other embodiments as illustrated in FIG. 35, the back surface 1416 of the body portion 1402 can comprise a non-level surface. For example, the first side 1410, the second side 1412, the first end portion 1406, and the second end portion 1408 can increase in elevation as it extends toward the clamp 1426.

The base 1404 of the portable electronic device holder 1400 is integrally formed with the body portion 1402 and extends from the second end portion 1408 of the front surface 1414. The base extends the entire width 1422 of the body portion 1402. Furthermore, the base 1404 is perpendicular relative to the body portion 1402. The base 1404 prevents the portable electronic device 1000 from rotation when mounted to the body portion 1402.

The body portion 1402 further comprises at least one recess 1418 (e.g., 1 recess, 2 recesses, 3 recesses, 4 recesses, 5 recesses, or 6 recesses), wherein the at least one recess 1418 is located on the front surface 1414. The at least one recess can be positioned on any portion of the front surface, such as: centered along the width 1422 of the body portion 1402, centered along the length 1420 of the body portion 1402, closer to the first side 1410, closer to the second side 1412, closer to the first end portion 1406, closer to the second end portion 1408, in an alignment parallel to the first side 1410, in an alignment perpendicular to the first side 1410, aligned in a diagonal orientation, positioned at different corners of the body portion 1402, in a shape orientation (e.g., square, diamond, triangle, pentagon, etc.), or any combination thereof. For example as illustrated in FIG. 32, the body portion can comprise one recess 1418, centered along the width 1422 of the body portion 1402, and aligned perpendicular to the base 1404. Further the at least one recess 1418 can be any cross-sectional shape (e.g., circle, triangle, square, rectangle, etc.). The at least one recess 1418 described herein is a rectangular cross-sectional shape.

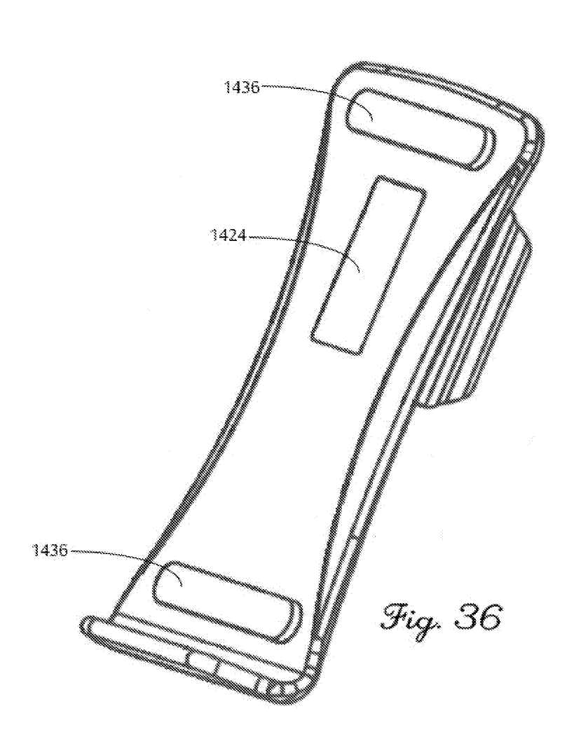

As illustrated in FIG. 36, the at least one recess 1418 can further house at least one magnet 1424, wherein the at least one magnet 1424 comprises a cross-sectional shape that is complementary to the cross-sectional shape of the at least one recess 1418. The at least one magnet 1424 may be positioned in the at least one recess 1418 by an adhesive (e.g., epoxy), press fit, molding a plastic of the portable electronic device holder 1400 around the at least one magnet 1424, 3-D printing the at least one magnet 1424 into the at least one recess 1418, providing a portable electronic device holder 1400 comprising a ferrous material (i.e. any material that is magnetic), or providing a portable electronic device holder 1400 comprising a polymagnet. When the at least one magnet 1424 is positioned in the at least one recess 1418, an exposed surface 1425 of the at least one magnet 1424 is flush with the front surface 1414. The exposed surface 1425 of the at least one magnet 1424 further comprises a polarity with respect to a magnetic field. The at least one magnet 1424, can be made of neodymium iron boron, samarium cobalt, alnico, ceramic, or any combination of ferromagnetic metals.

The body portion 1402 further comprises at least one cavity 1434 (e.g., 1 cavity, 2 cavities, 3 cavities, 4 cavities, or 5 cavities), wherein the at least one cavity 1434 is located on the front surface 1414. The at least one cavity 1434 can be positioned on any portion of the front surface 1414, such as: centered along the width 1422 of the body portion 1402 near the first end portion 1406, centered along the width 1422 near the second end portion 1408, centered along the with near both the first end portion 1406 and the second end portion 1408, closer to the first side 1410, closer to the second side 1412, or located at the corners of the front surface 1414. For example, the body portion 1402 comprises 2 cavities 1434, the first cavity 1434 centered along the width 1422 of the body portion 1402 near the first end portion 1406, and the second cavity 1434 centered along the width 1422 near the second end portion 1408. Further the at least one cavity 1434 can be any cross-sectional shape (e.g., circle, triangle, square, rectangle, etc.). The at least one cavity 1434 described herein is an oval cross-sectional shape.

The at least one cavity 1434 is configured to receive at least one friction pad 1436, wherein the at least one friction pad 1436 comprises a cross-sectional shape that is complementary to the cross-sectional shape of the at least one cavity 1434. The at least one friction pad 1436 may be positioned in the at least one cavity 1434 by an adhesive (e.g., epoxy), tape, press fit, or by any other attachment means. When the at least one friction pad 1436 is positioned in the at least one cavity 1434, the at least one friction pad 1436 can be flush with the front surface 1414. In other embodiments, the at least one friction pad 1436 is not flush with the front surface when positioned within the at least one cavity 1434, wherein the at least one friction pad 1436 can extend past the front surface 1414 by 0.05 inch to 0.30 inch. For example, the at least one friction pad 1436 can extend past the front surface 1414 by 0.05 inch, 0.10 inch, 0.15 inch, 0.20 inch, 0.25 inch, or 0.30 inch.

The at least one friction pad 1436 comprises a material. The material of the at least one friction pad 1436 can be polyethylene terephthalate, high-density polyethylene, polyvinyl chloride, polycarbonate, polypropylene, other thermoplastics, composite polymers, foams or any combination thereof. The material of the at least one friction pad 1436 provides friction for the portable electronic device 1000 and prevent the portable electronic device from rotating when coupled to the portable electronic device holder 1400.

When the at least one magnet 1424 is placed near another polymagnet or a ferrous material (e.g., alloy steel, carbon steel, stainless steel, cast iron, etc.), the magnetic field of the at least one magnet 1424 causes the ferrous material to polarize. A force of attraction due to the polarity of the ferrous material and the polarity of the at least one magnet 1424, couples the ferrous material to the at least one magnet 1424.

There are several different approaches to incorporate a ferrous material to the portable electronic device 1000 so the portable electronic device 1000 may mount the portable electronic device holder 1400. In one approach, the portable electronic device 1000 may have a portable electronic device case made of the ferrous material. In another approach, the portable electronic device 1000 may have a portable electronic device case with a metal sheet made of the ferrous material positioned in between the portable electronic device 1000 and the portable electronic device case. The metal sheet comprises an adhesive surface wherein the adhesive surface can directly attach to the portable electronic device 1000 or to the portable electronic device case. The metal sheet can further comprise a design or logo on the surface opposite the adhesive surface. The force of attraction between the at least one magnet 1424 and the metal sheet, or the portable electronic device case made of the ferrous material, will keep the portable electronic device 1000 coupled to the portable electronic device holder 1400 until removal by a user. Further, the magnetic field of the at least one magnet 1424 will not harm the portable electronic device 1000 when mounted onto the portable electronic device holder 1400.

To remove the portable electronic device 1000 from the portable electronic device holder 1400, the portable electronic device 1000 and the electronic device case may be pulled away from the body portion 1402 so that the magnetic fields of the at least one magnet 1424 and the metal sheet, or the portable electronic device case made of the ferrous material do not create a force of attraction to one another.

The portable electronic device holder 1400 may be mounted on a shaft of sports equipment or any cylindrical object. The portable electronic device holder 1400 may be mounted on the golf club shaft 800. The portable electronic device holder 1400 may be further mounted on any other sport related shafts such as a polo stick, tennis racket, a hockey stick, or a lacrosse stick. The portable electronic device holder 1400 may engage the golf club shaft 800 at any location on the golf club shaft 800. A portable electronic device may be mounted on the golf club shaft 800 with the portable electronic device holder 1400 to capture still and/or video images of an area around the portable electronic device; measure and/or determine relative and/or absolute linear motion, velocity and/or acceleration of the portable electronic device; measure and/or determine relative and/or absolute angular motion, velocity and/or acceleration of the portable electronic device; and/or measure and/or determine relative and/or absolute position of the portable electronic device. Any of the above-described motion, velocity, acceleration and/or position measurements and/or determinations associated with the portable electronic device 1000 may be interpreted as motion, velocity, acceleration and/or position measurements and/or determinations associated with the golf club shaft 800.

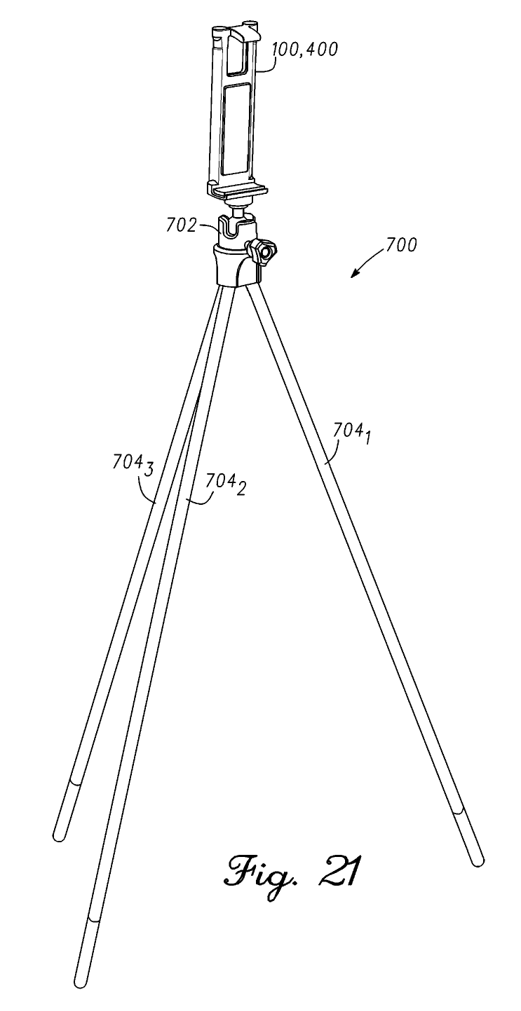

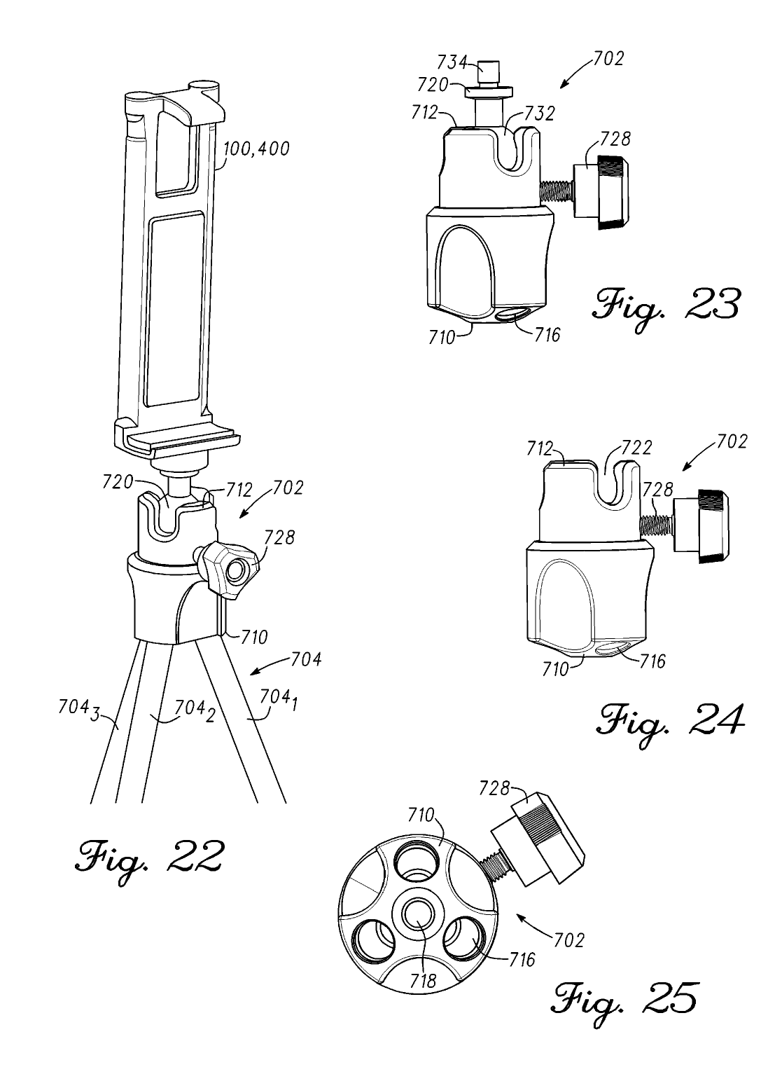

Referring to FIGS. 21-25, the portable electronic device holder 100, 400, 1100, 1200, 1300, 1400 may be configured to be removably attached to a stand system 700. In the illustrated embodiment, the stand system 700 includes a coupling member 702 and at least one leg 704. The coupling member 702 includes a first end 710 configured to removably receive the at least one leg 704 and/or a camera stand (not shown), and a second end 712 configured to removably receive the portable electronic device holder 100, 400, 1100, 1200, 1300, 1400.

Further referring to FIGS. 21-25, the first end of the coupling member 702 includes at least one cavity 716 configured to receive the at least one leg 704. The cavity 716 may have any shape corresponding to the cross sectional shape of the at least one leg 704. The at least one cavity 716 may include a substantially ring shaped securing member (not shown). The securing member may be made of a rubber-type material capable of frictionally engaging the at least one leg 704 to provide a secure press fit of the at least one leg 704 within the at least one cavity 716. The at least one leg 704 may be an alignment tool used for aligning a golfer's swing. The first end 710 of the coupling member 702 may further include a threaded inner surface 718 capable of receiving a camera stand having mating threads.

Further referring to FIGS. 21-25, the second end 712 of the coupling member 702 includes a ball member 720 positioned within a socket 722, and a threaded fastener 728 capable of provisionally fixing the ball member 720 within the socket 722 in a desired position. The ball member 720 includes a first portion 732 having a substantially spherical shape and a second portion 734 having threads capable of removably coupling the coupling member to a threaded inner surface 750 (shown in FIG. 13) of the portable electronic device holder. The position of the ball member 720 within with socket 722 may be changed by loosening the threaded fastener 728, rotating the ball member 720 to a different position, and tightening the threaded fastener 728.

In the illustrated embodiment, the stand system includes a first leg 704₁, a second leg 704₂, and a third leg 704₃. The first, the second, and the third legs 704₁, 704₂, 704₃ are illustrated in FIG. 18 as alignment tools used to align a golfer's swing. The at least one leg 704 may also be other alignment tools, or any elongated shape capable of forming a stand system 700 with the coupling member 702. In the illustrated embodiment, the at least one leg 704 has an elongated shape with a substantially circular cross section matching a substantially circular cross section of the at least one cavity 716. In other embodiments, the at least one leg 704 may be any elongated shape having any cross sectional shape capable of removably coupling to the at least one cavity 716 in the first end 710 of the coupling member 702.

A golfer may attach the portable electronic device to the golf club shaft 800 or to the coupling member 702 using alignment tools as legs 704 to create a stand system 700. This flexibility provides the golfer with a variety of abilities such as, for example, tracking the position, velocity, acceleration of the golf club during a swing, recording a video of the swing of the golf club or impact of the golf club with a golf ball, or overall recording of the mechanics and tempos of a golfer's swing.

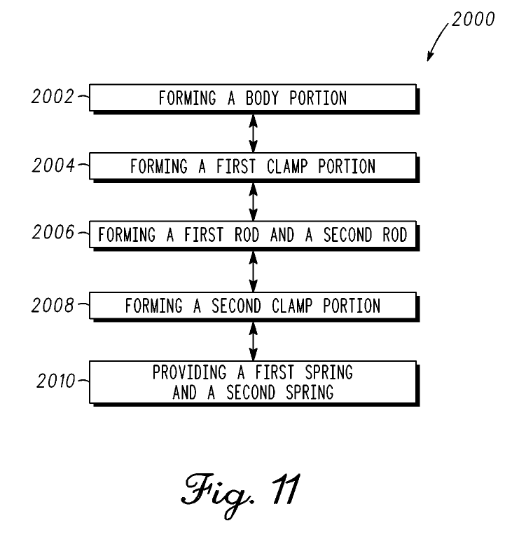

Referring to FIG. 11, a method 2000 of manufacturing an exemplary portable electronic device holder is shown. The method 2000 may include forming a body portion (block 2002), forming a first clamp portion (block 2004), forming a first rod and a second rod (block 2006), forming a second clamp portion (block 2008), and providing a first spring and a second spring (block 2010). The second clamp portion may be formed with the body portion as a single unit. The springs may be formed by any of the processes described herein. Additionally, the first rod and the second rod may be formed together with the first clamp portion.

Any single part or multiple parts of the portable electronic device holder may be constructed from any type of material, such as stainless steel, aluminum, titanium, various metals or metal alloys, composite materials (e.g., Kevlar®, graphite and/or fiberglass), natural materials such as wood or stone or artificial materials such as plastic. Any single part or multiple parts of the portable electronic device holder, such as the body portion, the first and second rods, the first clamp portion and/or the springs may be constructed by stamping (i.e., punching using a machine press or a stamping press, blanking, embossing, bending, flanging, coining, or casting), injection molding, forging, machining or a combination thereof, or other processes used for manufacturing metal, composite, plastic or wood parts. The first and second springs may be coil springs, leaf springs, radial springs, elastomer springs (e.g., annular or cylindrical elastomeric parts) or be constructed with any material and/or have any shape to provide the functions described herein. For example, the body portion including the second clamp portion, the first and second rods and the first clamp portion may be constructed from plastic by an injection molding process. The springs for example may be steel or plastic coil springs. The body portion including the second clamp portion, the first and second rods, the springs and the first clamp portion may then be assembled to form the portable electronic device holder. The body portion or any other part of the portable electronic device holder may be constructed in multiple sections that may be joined together during assembly of the portable electronic device holder. For example, the body portion may be constructed as two halves that are joined together during assembly of the portable electronic device holder.

The above examples are described in connection with a golf club such as a putter-type golf club, a driver-type golf club, a fairway wood-type golf club, a hybrid-type golf club, an iron-type golf club, or a wedge-type golf club. However, the apparatus and articles of manufacture described herein may be applicable other types of sports equipment such as a hockey stick, a tennis racket, a fishing pole, a ski pole, etc.

Although a particular order of actions is described above, these actions may be performed in other temporal sequences. For example, two or more actions described above may be performed sequentially, concurrently, or simultaneously. Alternatively, two or more actions may be performed in reversed order. Further, one or more actions described above may not be performed at all. The apparatus, methods, and articles of manufacture described herein are not limited in this regard.

Although certain example methods, apparatus, systems, and articles of manufacture have been described herein, the scope of coverage of this disclosure is not limited thereto. On the contrary, this disclosure covers all methods, apparatus, systems, and articles of manufacture fairly falling within the scope of the appended claims either literally or under the doctrine of equivalents.

1. A portable electronic device holder of a golf club comprising:
a first side;
a second side;
a front surface perpendicular to the first side and the second side;
a back surface opposite the front surface;
a first end portion;
a second end portion; and
a base extending from the second end portion and is perpendicular to the front surface;
wherein
the front surface comprises at least one recess, and at least one magnet, wherein the at least one magnet is a polymagnet, and is positioned in the at least one recess; and
the back surface comprises a clamp;
wherein
the clamp comprises a first arm and a second arm.

2. The portable electronic device holder of claim 1, wherein:
the at least one recess is centered between the first end portion and the second end portion, and is selected from the following group:
closer to the first side, closer to the second side, and centered in between the first side and the second side.

3. The portable electronic device holder of claim 1, wherein:
the front surface comprises two recesses, and two magnets positioned in the two recesses.

4. The portable electronic device holder of claim 3, wherein:
the two recesses are aligned and are selected from the following group:
closer to the first side, closer to the second side, and centered in between the first side and the second side.

5. The portable electronic device holder of claim 1, wherein:
the front surface comprises four recesses, and four magnets positioned in the four recesses.

6. The portable electronic device holder of claim 5, wherein:
the four recesses are in a square orientation and are either parallel to the first side, or perpendicular to the first side.

7. The portable electronic device holder of claim 5, wherein:
the four recesses are at each corner on the front surface.

8. The portable electronic device holder of claim 5, wherein:
the four recesses are either aligned in a straight line parallel to the first side, or aligned in a straight line diagonal relative to the first side.

9. The portable electronic device holder of claim 1, wherein:
the at least one recess and the at least one magnet comprises a cross-sectional shape, and the at least one magnet is complementary to the at least one recess.

10. The portable electronic device holder of claim 9, wherein:
the cross-sectional shape of the at least one recess and the at least one magnet are selected from a group consisting of:
a circle, a triangle, a square, and a rectangle.

11. The portable electronic device holder of claim 1, wherein:
the at least one magnet comprises an exposed surface when positioned in the at least one recess, and the exposed surface of the at last one magnet is flush with the front surface of the portable electronic device holder.

12. The portable electronic device holder of claim 1, wherein:
the at least one magnet is positioned in the at least one recess selected from a group consisting of:
an adhesive, press fit, molding a plastic of the portable electronic device holder around the magnet, 3-D printing the magnet into the recess, and comprising the portable electronic device holder of a ferrous material.

13. The portable electronic device holder of claim 1, wherein:
the first arm and the second arm collectively comprise a radius which varies to accommodate different sized cylindrical objects.

14. The portable electronic device holder of claim 1, wherein:
a cylindrical object is received through an opening disposed between the first arm and the second arm and snapped onto the portable electronic device holder, wherein a friction is generated between the cylindrical object and the first and second arm.

15. The portable electronic device holder of claim 1, wherein:
the orientation of the clamp is either parallel relative to the first side, or perpendicular relative to the first side.
